(19) United States
(12) Patent Application Publication
(10) Pub. No.: US 2025/0214628 A1
(43) Pub. Date: Jul. 3, 2025

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventors: Akihisa OYA, Osaka (JP); Motoshi Anabuki, Hyogo (JP); Shunsuke Kuhara, Osaka (JP); Toshiya Arai, Osaka (JP)

(21) Appl. No.: 19/062,542

(22) Filed: Feb. 25, 2025

Related U.S. Application Data
(63) Continuation of application No. PCT/JP2023/029464, filed on Aug. 14, 2023.

(30) Foreign Application Priority Data
Sep. 5, 2022 (JP) 2022-141087

(51) Int. Cl. B60W 60/00; B60W 30/095; B60W 50/14; G08G 1/16

(52) U.S. Cl. CPC B60W 60/0027; B60W 30/0956; B60W 50/14; G08G 1/166; B60W 2420/403; B60W 2554/402; B60W 2554/4029; B60W 2554/4044; B60W 2554/4049; B60W 2556/45

(57) ABSTRACT

An information processing method includes: obtaining sensing information generated by sensing a vicinity of a first mobile body that travels autonomously; detecting a second mobile body present in the vicinity of the first mobile body, based on the sensing information; determining, when at least two second mobile bodies are detected as the second mobile body present in the vicinity of the first mobile body, whether the at least two second mobile bodies have a predetermined relationship, based on the sensing information; and executing, when the determining is made that the at least two second mobile bodies have the predetermined relationship, a predetermined operation to avoid contact between the first mobile body and the at least two second mobile bodies.

### CROSS REFERENCE TO RELATED APPLICATIONS

This is a continuation application of PCT International Application No. PCT/JP2023/029464 filed on Aug. 14, 2023, designating the United States of America, which is based on and claims priority of Japanese Patent Application No. 2022-141087 filed on Sep. 5, 2022. The entire disclosures of the above-identified applications, including the specifications, drawings and claims are incorporated herein by reference in their entirety.

### FIELD

The present disclosure relates to an information processing method, an information processing device, and a recording medium.

### BACKGROUND

To improve safety in driving a vehicle, a method has been developed to: detect a mobile body, such as a pedestrian, a bicycle, a wheelchair, a stroller, or a pet, present in the vicinity of the vehicle; calculate a risk posed by the vehicle to the detected mobile body; and change a parameter or medium of unrecognized notice information according to the calculated risk (see Patent Literature (PTL) 1, for example).

When the mobile body present in the vicinity of the vehicle is a person, the method disclosed in PTL 1 is able to provide caution to the person even when the vehicle does not recognize the person.

### CITATION LIST

### Patent Literature

PTL 1: Japanese Unexamined Patent Application Publication No. 2021-149309

### SUMMARY

### Technical Problem

However, by the method disclosed in PTL 1, for parent-and-child pedestrians holding hands in the vicinity of the vehicle, the risk is individually calculated for each of the parent pedestrian and the child pedestrian. For example, the risk to the child pedestrian holding hands with the parent pedestrian is assumed to be lower than the risk to a child pedestrian who is alone. Thus, for a mobile body belonging to a group, the method disclosed in PTL 1 lacks reflection of contribution of influence on the risk from another member in the group. Due to the risk resultantly assessed higher than necessary, unnecessary control is performed on the vehicle and this may result in a decrease in the vehicle operating efficiency. Furthermore, due to the risk assessed as low, sufficient control is not performed on the vehicle and this may expose the mobile body to danger.

In response to the above issue, it is an object of the present disclosure to provide an information processing method and so forth that enable necessary and sufficient control to be performed on a mobile body, such as a vehicle.

### Solution to Problem

In accordance with an aspect of the present disclosure, an information processing method executed by an information processing device includes: obtaining sensing information generated by sensing a vicinity of a first mobile body that travels autonomously; detecting a second mobile body present in the vicinity of the first mobile body, based on the sensing information obtained in the obtaining; determining, when at least two second mobile bodies are detected in the detecting as the second mobile body present in the vicinity of the first mobile body, whether the at least two second mobile bodies have a predetermined relationship, based on the sensing information; and executing, when the determining is made that the at least two second mobile bodies have the predetermined relationship, a predetermined operation to avoid contact between the first mobile body and the at least two second mobile bodies.

General or specific aspects of the present disclosure may be implemented to a system, a method, an integrated circuit, a computer program, a computer-readable recording medium such as a Compact Disc-Read Only Memory (CD-ROM), or any given combination thereof. The recording medium may be a non-transitory recording medium.

### Advantageous Effects

The information processing method according to the present disclosure enables necessary and sufficient control to be performed on a mobile body, such as a vehicle.

It should be noted that further advantages and effects of the aspect of the present disclosure are apparent from the Description and the Drawings. Such advantages and/or effects are provided from some embodiments and the features described in the Description and the Drawings. However, all of the embodiments and the features are not necessarily provided to obtain one or more features.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of an overall configuration including an information processing device according to Embodiment.

FIG. 2 is a block diagram illustrating an example of a configuration of a first mobile body according to Embodiment.

FIG. 3 is a block diagram illustrating an example of a configuration of a terminal according to Embodiment.

FIG. 4 is a block diagram illustrating an example of a configuration of the information processing device according to Embodiment.

FIG. 5A is a diagram illustrating an example of risk values corresponding to attributes of second mobile bodies according to Embodiment.

FIG. 5B is a diagram illustrating an example of risk values corresponding to the distance between the first mobile body and the second mobile body according to Embodiment.

FIG. 5C is a diagram illustrating an example of risk values corresponding to the speed of the first mobile body according to Embodiment.

FIG. 5D is a diagram illustrating an example of risk values corresponding to the speed of the second mobile body according to Embodiment.

FIG. 6 is a diagram illustrating an example of attributes used for calculating an individual risk according to Embodiment.

FIG. 7 is a diagram illustrating a conditional flowchart as an example of group determination information according to Embodiment.

FIG. 8A is a conceptual diagram illustrating an example case where two second mobile bodies have a predetermined relationship according to Embodiment.

FIG. 8B is a conceptual diagram illustrating an example case where two second mobile bodies have a predetermined relationship according to Embodiment.

FIG. 8C is a conceptual diagram illustrating an example case where two second mobile bodies have a predetermined relationship according to Embodiment.

FIG. 8D is a conceptual diagram illustrating an example case where two second mobile bodies have a predetermined relationship according to Embodiment.

FIG. 8E is a conceptual diagram illustrating an example case where two second mobile bodies have a predetermined relationship according to Embodiment.

FIG. 9 is a diagram illustrating examples of condition for determining whether a predetermined relationship is present according to Embodiment.

FIG. 10 is a diagram illustrating examples of a risk correction value according to Embodiment.

FIG. 11 is a conceptual diagram illustrating an example of risk correction reflecting an influence of a different second mobile body in the same group according to Embodiment.

FIG. 12 is a conceptual diagram illustrating an example of risk correction reflecting an influence of a different second mobile body in the same group according to Embodiment.

FIG. 13 is a conceptual diagram illustrating an example of risk correction reflecting an influence of a different second mobile body in the same group according to Embodiment.

FIG. 14 is a conceptual diagram illustrating an example of risk correction reflecting an influence of a different second mobile body in the same group according to Embodiment.

FIG. 15 is a diagram illustrating an example of information generated based on a corrected individual risk value according to Embodiment.

FIG. 16 is a sequence diagram illustrating an operation of the overall structure including the information processing device according to Embodiment.

FIG. 17 is a flowchart illustrating an example of an operation performed by the information processing device according to Embodiment.

FIG. 18 is a flowchart illustrating an example of details of Step S307 illustrated in FIG. 17.

FIG. 19A is a conceptual diagram illustrating a risk calculated for a situation by a method according a comparison example.

FIG. 19B is a conceptual diagram illustrating a risk calculated for a situation by a method according Embodiment.

FIG. 20 is a conceptual diagram illustrating an example of risk correction reflecting an influence of a different second mobile body in the same group according to a variation of Embodiment.

FIG. 21 is a diagram illustrating control performed on a first mobile body when two second mobile bodies having a predetermined relationship avoid an obstacle, according to a variation of Embodiment.

FIG. 22 is a diagram illustrating an example of risk correction based on a positional relationship between second mobile bodies in a group and a first mobile body, according to a variation of Embodiment.

### DESCRIPTION OF EMBODIMENT

Hereinafter, certain exemplary embodiments will be described in detail with reference to the accompanying Drawings.

The following embodiments are general or specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

It should be noted that the respective figures are schematic diagrams and are not necessarily precise illustrations. Additionally, components that are essentially the same share like reference signs in the figures.

### Embodiment

The following is a description of an information processing method and an information processing device according to the present embodiment.

### 1 Overall Configuration

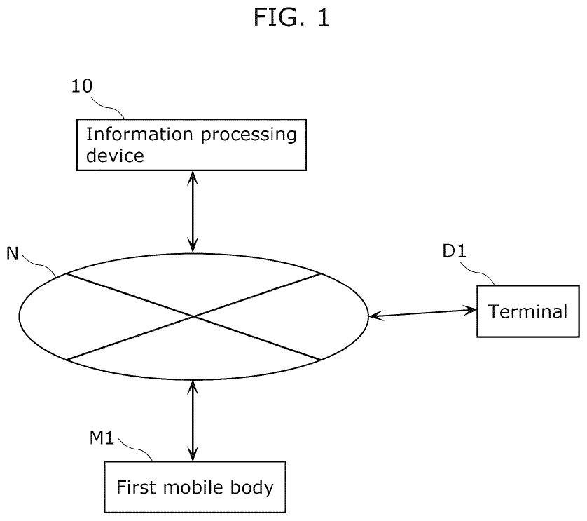

FIG. 1 is a diagram illustrating an example of an overall configuration including information processing device 10 according to the present embodiment.

The overall configuration illustrated in FIG. 1 includes information processing device 10, terminal D1 used by a remote supervisor, and first mobile body M1 that are mutually communicatively connected via network N. The remote supervisor is a staff member that remotely supervises and remotely controls first mobile body M1 via terminal D1. In other words, the overall configuration illustrated in FIG. 1 shows an information processing system in which the remote supervisor supervises first mobile body M1 and information processing device 10 to remotely supervise or remotely control first mobile body M1 based on information notified by terminal D1.

Network N is a predetermined wired or wireless communication network. Examples of network N include, but not limited to, a mobile telephone network, a satellite communication network, and a wide area communication network using, for example, Wi-Fi technology. Each of information processing device 10, terminal D1, and first mobile body M1 may be disposed in any physical location where communicative connection to network N is available.

Note that although the overall configuration according to the present embodiment includes a single first mobile body M1 and a single terminal D1 as illustrated in FIG. 1, this is not intended to be limiting. Two or more first mobile bodies M1 and two or more terminals D1 may be included. Moreover, terminal D1 and information processing device 10 may be integrated. Alternatively, the overall configuration illustrated in FIG. 1 need not include terminal D1 and may include only information processing device 10 and first mobile body M1.

### 1.1 First Mobile Body M1

First mobile body M1 is, for example, a mobile robot or a vehicle that travels autonomously. Furthermore, first mobile body M1 is operable through at least one of remote operation or remote supervision performed by the remote supervisor. First mobile body M1 is not limited to a mobile robot or a vehicle, and may be any one of an automated guided vehicle (AGV), a personal mobility device, a plane, a drone, a ship, a mobile robot, a construction machine, or an agricultural machine (such as a tractor), for example. When first mobile body M1 is a vehicle, a person may be on board or need not be on board. Note that, when first mobile body M1 is a vehicle, the vehicle may be an autonomous driving vehicle or may be a vehicle that is not an autonomous driving vehicle and driven by an on-board driver. In the present embodiment, the steering angle, the acceleration, the deceleration, or the like of first mobile body M1 may be controlled based on a result of processing by information processing device 10 or based on details of input made to terminal D1 by the remote supervisor.

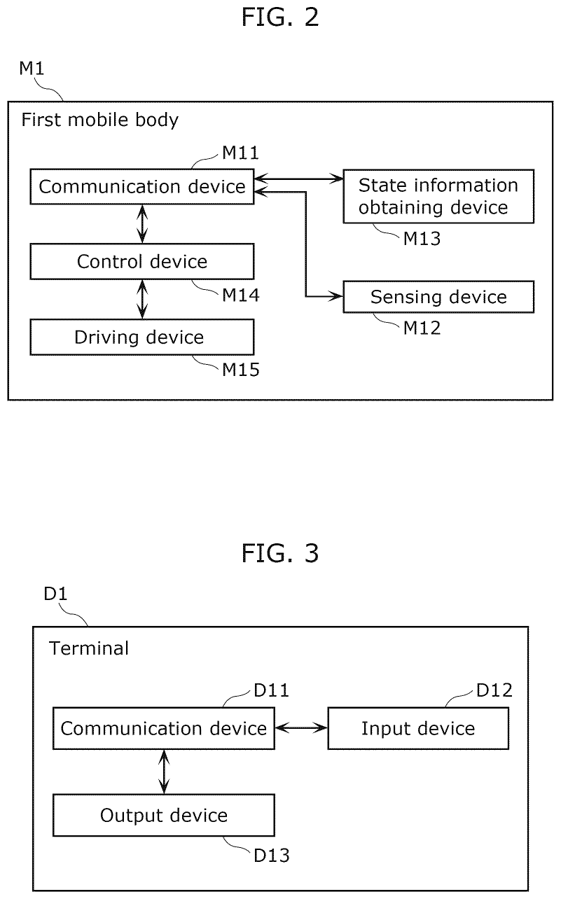

FIG. 2 is a block diagram illustrating an example of a configuration of first mobile body M1 according to the present embodiment.

As illustrated in FIG. 2, first mobile body M1 includes communication device M11, sensing device M12, state information obtaining device M13, control device M14, and driving device M15.

Communication device M11 is a communication interface, for example, and is connectable to network N. Communication device M11 is communicatively connected to information processing device 10 via network N. As described later, communication device M11 periodically transmits state information and sensing information to information processing device 10.

Sensing device M12 is a camera or a light detection and ranging (LIDAR) device, for example. By imaging the surroundings of first mobile body M1, sensing device M12 obtains sensing information. For example, the sensing information may be image information generated by imaging the surroundings of first mobile body M1, or video information that includes at least one piece of image information generated by imaging the surroundings of first mobile body M1. Furthermore, sensing device M12 obtains the sensing information at predetermined intervals, or equivalently, periodically. Note that imaging is an example of sensing.

State information obtaining device M13 includes various sensers. By detecting state information on a traveling state of first mobile body M1, state information obtaining device M13 obtains the state information on the traveling state of first mobile body M1. Here, the state information may include a traveling speed, a traveling direction, and a traveling state of first mobile body M1. For example, the traveling state indicates that first mobile body M1 is currently travelling, stationary, or at a temporary stop. A global positioning system (GPS) may be included among the various sensers.

Note that the state information may also include: position information on first mobile body M1; the speed, acceleration, jerk, angle, direction, and steering angle of first mobile body M1; remaining fuel; and an operating status of a direction indicator. Furthermore, the state information may also include an operating status of an anti-lock braking system (ABS) and an operating status of an automatic emergency braking (AEB) system. Furthermore, the state information may also include: the presence or absence of any object in the vicinity of first mobile body M1; the number and kind of such surrounding objects; a distance from such a surrounding object; a speed difference from the speed of such a surrounding object; weather condition; surrounding sound information; acceleration difference; an angle at which sensing device M12 is mounted on first mobile body M1; and position information. The state information may include the various pieces of information described above. The various pieces are also referred to as the types of the state information. More specifically, the number of types of the state information may be more than one.

Furthermore, state information obtaining device M13 obtains the state information using the various sensers at predetermined intervals, or equivalently, periodically.

Control device M14 includes a computer, and controls the speed and the steering of driving device M15 with the computer. Control device M14 is also able to control the speed and the steering of driving device M15 with the computer, in response to an operation performed by the on-board driver or the remote supervisor.

Driving device M15 includes: a driving body, such as the wheels of first mobile body M1; a motor; and an engine. Driving device M15 is controlled by control device M14.

### 1.2 Terminal D1

Terminal D1 is capable of verifying the state information on first mobile body M1 and verifying the result of processing performed by information processing device 10. Furthermore, terminal D1 may control information processing device 10 and first mobile body M1 according to details of input made by the remote supervisor.

FIG. 3 is a block diagram illustrating an example of a configuration of terminal D1 according to the present embodiment.

As illustrated in FIG. 3, terminal D1 includes communication device D11, input device D12, and output device D13.

Communication device D11 is a communication interface, for example, and is connectable to network N. Communication device D11 is communicatively connected to information processing device 10 or first mobile body M1 via network N.

Input device D12 includes a joystick, a touch screen handle, and buttons, for example. Input device D12 receives input information inputted by the remote supervisor. This input information refers to information on the control over the acceleration and steering angle of first mobile body M1 via network N or information on set values for information processing performed by information processing device 10.

Output device D13 includes a display, a loudspeaker, and a light, for example. Output device D13 is controlled based on notice information obtained from information processing device 10 and first mobile body M1. For example, the notice information may include running information on information processing device 10 and first mobile body M1 and instruction information for displaying the running information. Although the notice information may include the instruction information for displaying the running information, this is not intended to be limiting. The notice information may also include instruction information for causing an object on a screen of the display to flash, for activating the buttons, and for enabling a speech utterance, for example.

### 1.3 Information Processing Device 10

Information processing device 10 is a server, for example, and executes an information processing method according to the present embodiment.

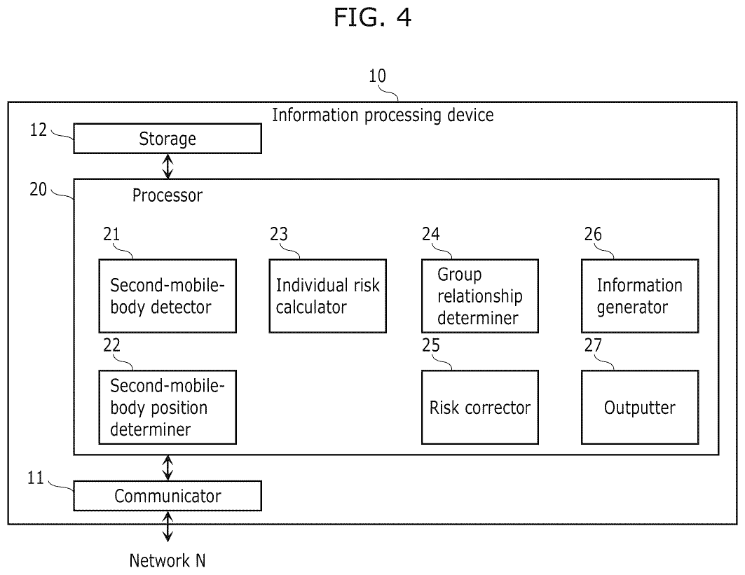

FIG. 4 is a block diagram illustrating an example of a configuration of information processing device 10 according to the present embodiment.

As illustrated in FIG. 4, information processing device 10 includes communicator 11, storage 12, and processor 20.

Communicator 11 is a communication interface, for example, and is connectable to network N. Communicator 11 is communicatively connected to first mobile body M1 and terminal D1 via network N. Communicator 11 obtains the state information on the traveling state of first mobile body M1 that travels autonomously and the sensing information generated by imaging the surroundings of first mobile body M1. Communicator 11 is an example of an obtainer according to the present disclosure.

In the present embodiment, communicator 11 receives the input information transmitted from terminal D1, and receives the state information and the sensing information transmitted from first mobile body M1. Note that communicator 11 may also obtain environmental information including: information on a road on which first mobile body M1 is traveling; a traffic condition on this road; and terrain information on this road. Then, communicator 11 may store the environmental information into storage 12.

Furthermore, communicator 11 transmits the notice information generated by processor 20 to terminal D1, and transmits the control information generated by processor 20 to first mobile body M1 via terminal D1. Thus, terminal D1 and first mobile body M1 are controlled according to the notice information and the control information.

Storage 12 is a database storing information for the processing performed by processor 20. Storage 12 is implemented by a hard disk drive (HDD) or a solid-state drive (SSD), for example.

In the present embodiment, storage 12 holds information necessary to detect the second mobile body and determine the position of the second mobile body. The necessary information refers to a data set for image recognition and set values for transforming coordinates on an image into position coordinates, for example. Furthermore, storage 12 holds information for calculating an individual risk, group determination information for determining whether at least two second mobile bodies belong to a group, and information for associating a risk with control details.

Storage 12 is described later.

### 1.3.1 Processor 20

Based on the information obtained from communicator 11 and storage 12, processor 20 generates the notice information for terminal D1 and the control information for first mobile body M1.

As illustrated in FIG. 4, processor 20 includes second-mobile-body detector 21, second-mobile-body position determiner 22, individual risk calculator 23, group relationship determiner 24, risk corrector 25, information generator 26, and outputter 27. Processor 20 includes a computer including a memory and a processor (a microprocessor) for example. Various functions of structural components can be achieved by the processor executing predetermined programs stored in the memory.

### 1.3.2 Second-Mobile-Body Detector 21

Based on the obtained sensing information, second-mobile-body detector 21 detects at least two second mobile bodies present in the vicinity of first mobile body M1 and determines attributes for each of the at least two second mobile bodies.

The processor executes the predetermined programs stored in the memory. This enables second-mobile-body detector 21 to perform functions, such as a detection function and an attribute determination function. Here, the second mobile body is a living body that can possibly come into contact with or collide with first mobile body M1, or is a conveyance in which a person is riding. Examples of the second mobile body include a pedestrian, a bicycle, a wheelchair, a stroller, a mobility scooter for seniors, and a pet. Furthermore, the second mobile body is different from first mobile body M1. More specifically, the second mobile body is not a vehicle nor a mobile robot.

In the present embodiment, second-mobile-body detector 21 obtains, from storage 12, the information necessary to detect the second mobile body. Then, second-mobile-body detector 21 detects the second mobile body using the obtained necessary information and, for example, the video information on first mobile body M1 obtained by communicator 11. Furthermore, second-mobile-body detector 21 determines the attributes for each second mobile body from, for example, the video information on first mobile body M1 obtained by communicator 11. Here, the attributes of the second mobile body include age, gender, height, clothes, orientation, and posture. Here, note that the processor executes the predetermined program stored in the memory to perform image recognition through, for example, machine learning by deep learning and other AI technologies. This enables second-mobile-body detector 21 to detect the second mobile body and determine the attributes of the second mobile body.

### 1.3.3 Second-Mobile-Body Position Determiner 22

Second-mobile-body position determiner 22 determines the position for each of the at least two second mobile bodies detected by second-mobile-body detector 21. Here, the processor executes the predetermined program stored in the memory. This enables second-mobile-body position determiner 22 to perform the function, such as a position determination function.

In the present embodiment, second-mobile-body position determiner 22 determines coordinates of the second mobile body detected on the image by second-mobile-body position determiner Second-mobile-body position determiner 22 obtains the 22. information necessary to determine the position, such as information on the height of a camera of first mobile body M1. Then, second-mobile-body position determiner 22 transforms position coordinates of the second mobile body detected on the image into position coordinates of the second mobile body with respect to first mobile body M1. In this way, second-mobile-body position determiner 22 determines the position of the second mobile body detected by second-mobile-body detector 21, with respect to first mobile body M1.

Note that when the state information includes the position coordinates and direction of first mobile body M1, the position information on the camera, the tilt of the camera, and the field of view of the camera, second-mobile-body position determiner 22 may calculate the position coordinates of the second mobile body using these pieces of information included in the state information. Furthermore, second-mobile-body position determiner 22 may calculate speed information and acceleration information on the second mobile body with respect to first mobile body M1, based on temporal changes in the calculated position information on the second mobile body.

### 1.3.4 Individual Risk Calculator 23

Based on the state information obtained by communicator 11 and the position determined by second-mobile-body detector 21, individual risk calculator 23 calculates, for each of the at least two second mobile bodies, an individual risk indicating a possibility of coming into contact with first mobile body M1. Here, the processor executes the predetermined program stored in the memory. This enables individual risk calculator 23 to perform a calculation function. Note that individual risk calculator 23 may calculate the individual risk, based on at least the respective positions of first mobile body M1 and a corresponding one of the at least two second mobile bodies (for example, the positional relationship between first mobile body M1 and the corresponding one of the at least two second mobile bodies).

In the present embodiment, individual risk calculator 23 is able to perform the calculation by checking the attributes determined for each second mobile body by second-mobile-body detector 21 and the position information, the speed information, and the acceleration information obtained by second-mobile-body position determiner 22 against reference information for the risk calculation.

Hereafter, the reference information for the risk calculation is described.

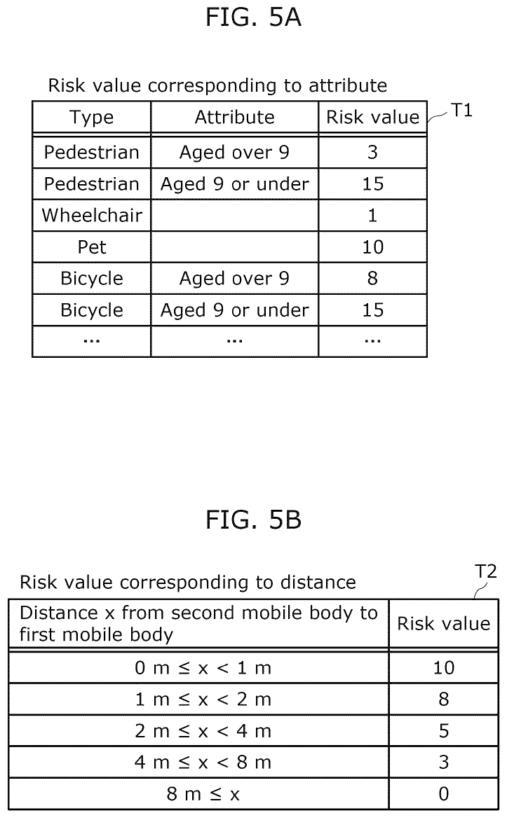

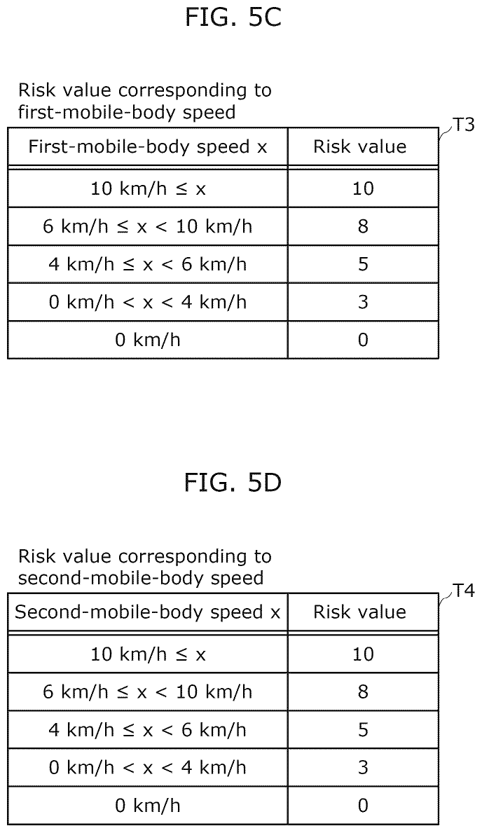

FIG. 5A is a diagram illustrating an example of risk values corresponding to attributes of the second mobile bodies according to the present embodiment. Table T1 in FIG. 5A shows an example of the risk value corresponding to the age as the attribute of the second mobile body that is a pedestrian, a wheelchair, a pet, or a bicycle. In the example illustrated in FIG. 5A, the risk value is different depending on whether the second mobile body is aged over 9, or aged 9 or under, at which time such person is less likely to have the sense of right and wrong.

FIG. 5B is a diagram illustrating an example of risk values corresponding to the distance between the first mobile body and the second mobile body according to the present embodiment. Table T2 in FIG. 5B shows an example of the risk value that increases as the distance between first mobile body M1 and the second mobile body decreases. FIG. 5C is a diagram illustrating an example of risk values corresponding to the speed of the first mobile body according to the present embodiment. Table T3 in FIG. 5C shows an example of the risk value that increases as the speed of first mobile body M1 increases. FIG. 5D is a diagram illustrating an example of risk values corresponding to the speed of the second mobile body according to the present embodiment. Table T4 in FIG. 5D shows an example of the risk value that increases as the speed of the second mobile body increases.

In the present embodiment, the risk indicates a level of possibility that the second mobile body collides with first mobile body M1 that is a vehicle for example, and may be expressed numerically. The individual risk for each of the at least two second mobile bodies indicates a level of possibility that the second mobile body (individually) comes into contact (collides) with first mobile body M1. Note that the risk may be calculated using a combination of pieces of information indicating a plurality of risk values. To be more specific, based on the determined attributes of the second mobile body and the determined position coordinates, individual risk calculator 23 may determine the risk values as indicated in table T1 of FIG. 5A, table T2 of FIG. 5B, table T3 of FIG. 5C, and table T4 of FIG. 5D. Then, individual risk calculator 23 may calculate the individual risk by combining the determined risk values. Examples of the method of combining the determined risk values include addition, subtraction, multiplication, and division.

Note that when the individual risk is calculated using tables T1 to T4 illustrated in FIG. 5A to FIG. 5D, tables T1 to T4 illustrated in FIG. 5A to FIG. 5D are held in storage 12.

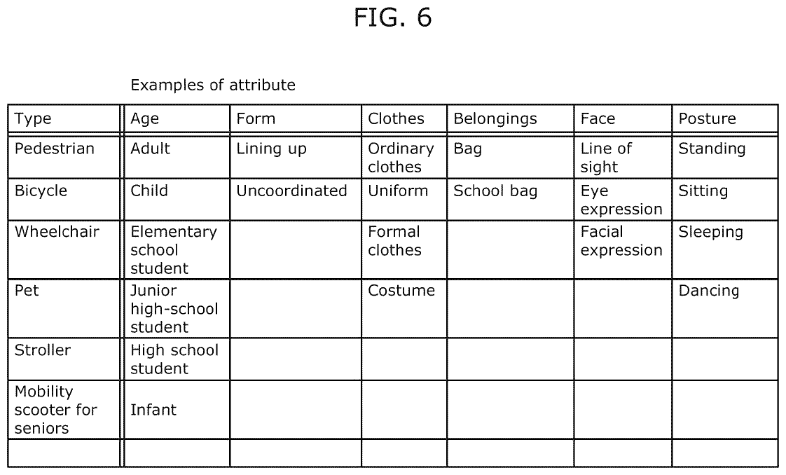

The attributes used by individual risk calculator 23 for calculating the individual risk are not limited to the attributes illustrated in FIG. 5A. For example, attributes obtained by combining at least one element that is included in the attributes as illustrated in FIG. 6 may be used for calculating the individual risk. Here, FIG. 6 is a diagram illustrating an example of attributes (an example of elements included in attributes) used for calculating an individual risk according to the present embodiment.

Examples of risk tendency depending on the attributes of a pedestrian are described. The individual risk is calculated based on such risk tendency as a premise. As for the age attribute for example, a child is likely to be more curious than an adult and has a higher risk tendency to approach first mobile body M1. As for the gender attribute, a boy has a higher risk tendency to approach first mobile body M1 than a girl. The clothes attribute includes elements including uniform and ordinary clothes, for example. A pedestrian in uniform is likely to give priority to the travel to or from school and thus has a low risk tendency to approach first mobile body M1. The face attribute includes elements including line of sight and facial expression. For example, when a pedestrian is looking at first mobile body M1, this pedestrian has an interest and a low risk tendency to approach first mobile body M1. The situation attribute includes elements including a hand-in-hand situation and a carried-in-arms situation. For example, when the hand of a pedestrian is held by someone or the pedestrian is carried in the arms of someone, the pedestrian has a low risk tendency to approach first mobile body M1. As for the traveling speed-direction attribute, the risk tendency to approach first mobile body M1 increases as the traveling speed of the pedestrian who is traveling toward first mobile body M1 increases. As for another attribute, the risk tendency to approach first mobile body M1 is low when an obstacle, such as a fence, is present between the pedestrian and first mobile body M1. As for another attribute, the risk tendency to approach first mobile body M1 is low when the pedestrian is speaking in a loud voice or having a conversation about first mobile body M1.

Note that individual risk calculator 23 may also calculate the individual risk based on the environmental information. For example, suppose that individual risk calculator 23 is able to determine, based on the terrain information, a plurality of pedestrians as a plurality of second mobile bodies detected are present at the bottom of a cliff. In this case, individual risk calculator 23 may determine a risk value indicating a low risk to approach first mobile body M1 and then calculate the individual risk by combining this risk value with another risk value determined separately.

### 1.3.5 Group Relationship Determiner 24

Group relationship determiner 24 determines, based on the determined position and attribute, whether the at least two second mobile bodies have a predetermined relationship. For example, group relationship determiner 24 determines whether the at least two second mobile bodies have the predetermined relationship, based on group determination information on at least one of distance, line of sight, physical connection, belongings, movements, ages, or voices, detected between the at least two second mobile bodies. When the plurality of second mobile bodies have the predetermined relationship, it is determined that the plurality of second mobile bodies belong to a group.

The processor executes the predetermined program stored in the memory. This enables group relationship determiner 24 to perform the aforementioned determination function.

In the present embodiment, when second-mobile-body detector 21 detects a plurality of second mobile bodies, group relationship determiner 24 obtains the group determination information stored in storage 12. Group relationship determiner 24 determines, using the obtained group determination information, whether the plurality of second mobile bodies have the predetermined relationship. For example, when a plurality of second mobile bodies are detected, group relationship determiner 24 may first determine a group of the plurality of second mobile bodies detected and members of the group. Following this, based on the attributes of the plurality of second mobile bodies detected and their position information with respect to first mobile body M1, group relationship determiner 24 may determine, using the obtained group determination information, whether the plurality of second mobile bodies have the predetermined relationship.

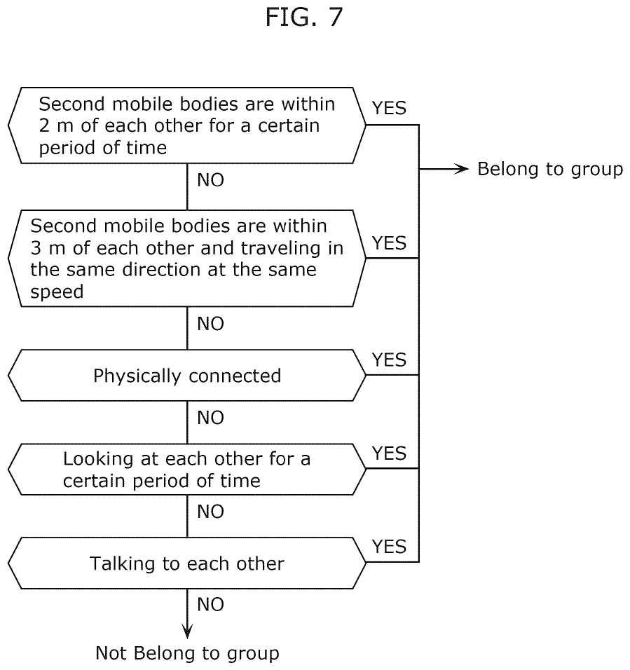

FIG. 7 is a diagram illustrating a conditional flowchart as an example of the group determination information according to the present embodiment.

Here, the group determination information includes conditions (set values), such as a time length and a distance indicating the predetermined relationship. As illustrated by the conditional flowchart in FIG. 7, the group determination information may include the conditions indicating the predetermined relationship in a form of conditional branching. In this case, group relationship determiner 24 is able to determine whether the plurality of second mobile bodies have the predetermined relationship according to the conditional flowchart illustrated in FIG. 7. In the example illustrated in FIG. 7, when the detected second mobile bodies are within 2 m of each other for at least a certain period of time for example, group relationship determiner 24 determines that the plurality of second mobile bodies have the predetermined relationship and belong to a group. Similarly, group relationship determiner 24 determines that the plurality of second mobile bodies have the predetermined relationship when, for example: the second mobile bodies are within 3 m of each other and traveling in the same direction at the same speed; the second mobile bodies are physically connected to each other; the second mobile bodies are looking at each other for a certain period of time; or the second mobile bodies are talking to each other. Note that group relationship determiner 24 may determine whether the second mobile bodies have the predetermined relationship, or more specifically, whether the second mobile bodies belong to the same group, based on at least the position information indicating that the second mobile bodies are within 2 m of each other, for example.

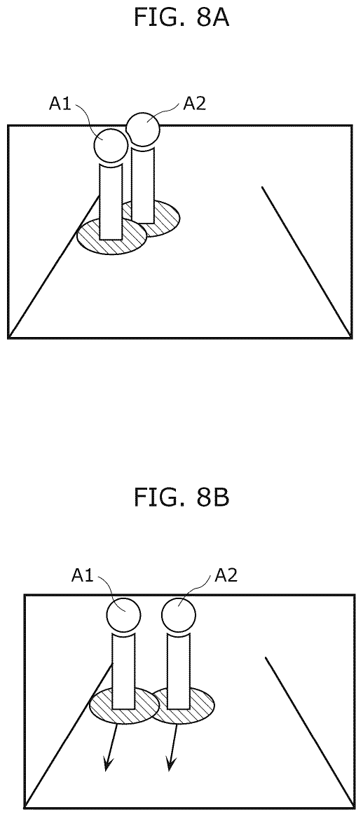

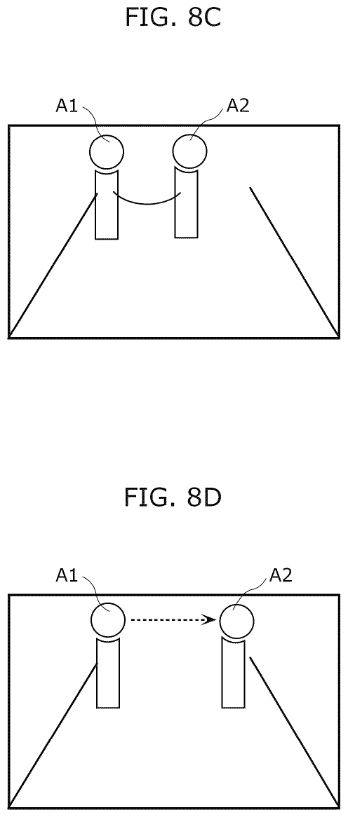

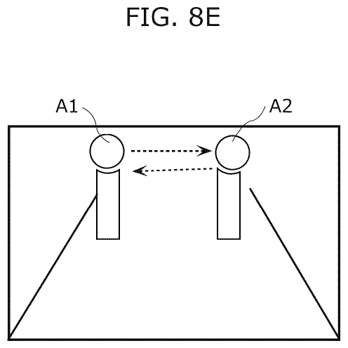

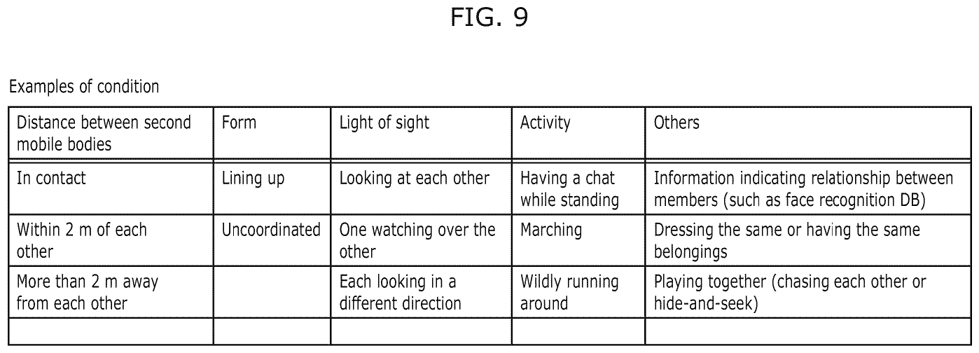

Here, the cases where it is determined that the plurality of second mobile bodies have the predetermined relationship are described conceptually, with reference to FIG. 8A to FIG. 8E.

Each of FIG. 8A to FIG. 8E is a conceptual diagram illustrating an example case where the two second mobile bodies have the predetermined relationship according to the present embodiment.

FIG. 8A illustrates an example case where second mobile body A1 and second mobile body A2 are both adult pedestrians and are stationary within a certain distance of each other. When second mobile body A1 and second mobile body A2 have the relationship as illustrated in FIG. 8A, group relationship determiner 24 can determine that second mobile body A1 and second mobile body A2 have the predetermined relationship and belong to a group.

FIG. 8B illustrates an example case where second mobile body A1 and second mobile body A2 are both adult pedestrians within a certain distance of each other and traveling in the same direction (traveling direction) at a constant speed. When second mobile body A1 and second mobile body A2 have the relationship as illustrated in FIG. 8B, group relationship determiner 24 can determine that second mobile body A1 and second mobile body A2 have the predetermined relationship and belong to a group.

Similarly, FIG. 8C illustrates an example case where second mobile body A1 and second mobile body A2 are both adult pedestrians and are physically connected, like holding hands, for example. When second mobile body A1 and second mobile body A2 have the relationship as illustrated in FIG. 8C, group relationship determiner 24 can determine that second mobile body A1 and second mobile body A2 have the predetermined relationship and belong to a group.

FIG. 8D illustrates an example case where second mobile body A1 and second mobile body A2 are both adult pedestrians, one of whom (second mobile body A1 in this diagram) is looking at the other of whom (second mobile body A2 in this diagram) to watch over second mobile body A2. When second mobile body A1 and second mobile body A2 have the relationship as illustrated in FIG. 8D, group relationship determiner 24 can determine that second mobile body A1 and second mobile body A2 have the predetermined relationship and belong to a group.

FIG. 8E illustrates an example case where second mobile body A1 and second mobile body A2 are both adult pedestrians and are looking at each other or having a conversation. When second mobile body A1 and second mobile body A2 have the relationship as illustrated in FIG. 8E, group relationship determiner 24 can determine that second mobile body A1 and second mobile body A2 have the predetermined relationship and belong to a group.

Note that the condition for determining that the plurality of second mobile bodies have the predetermined relationship is not limited to the conditions described with reference to FIG. 7 and FIG. 8A to FIG. 8E. For example, a condition made by combining elements as illustrated in FIG. 9 may also be used. Here, FIG. 9 is a diagram illustrating examples of the condition for determining whether the predetermined relationship is present according to the present embodiment.

More specifically, as illustrated in FIG. 9, for the condition that is the distance between the second mobile bodies, the elements may be “In contact”, “Within 2 m of each other”, and “More than 2 m away”. For the condition that is the form of the plurality of second mobile bodies, the elements may be “lining up” and “uncoordinated”. For the condition that is the line of sight of the plurality of second mobile bodies, the elements may be “Looking at each other”, “One watching over the other”, and “Each looking in a different direction”. Similarly, for the condition that is the activity of the plurality of second mobile bodies, the elements may be “Having a chat while standing”, “Marching”, “Wildly running around”. For the condition that is included in “Others”, the elements may be “Information indicating relationship between members”, “Dressing the same or having the same belongings”, and “Playing together”, for example. To be more specific, group relationship determiner 24 may determine whether the predetermined relationship is present by combining some of these elements and determining whether a condition including this combination of the elements is satisfied.

Note that, in addition to determining that the at least two second mobile bodies have the predetermined relationship and belong to the group, group relationship determiner 24 may also determine the situation of this group. For example, in addition to determining that the at least two second mobile bodies belong to the group, group relationship determiner 24 may also determine the ratio between adults and children in the group of the at least two second mobile bodies. This allows risk corrector 25, described later, to perform individual risk correction to reduce the individual risk as the number of children per adult decreases. As a result, a more accurate risk can be calculated for each of the at least two second mobile bodies. Furthermore, in addition to determining that the at least two second mobile bodies belong to the group, group relationship determiner 24 may also determine whether the at least two second mobile bodies of the group are lining up, for example. When the at least two second mobile bodies are walking in line, their destination and arrival time are usually known, such as when traveling to or from school. Thus, in this case, the correction is performed to reduce the individual risk. Furthermore, in addition to determining that the at least two second mobile bodies belong to the group, group relationship determiner 24 may also determine whether the group of the at least two second mobile bodies includes a member that is physically restrained, for example. When such a member is holding hands with someone or is on a leash, the correction is performed to reduce the individual risk. Furthermore, in addition to determining that the at least two second mobile bodies belong to the group, group relationship determiner 24 may also determine the situation of the conversation in the group of the at least two second mobile bodies. When the group is making a loud noise or talking about the vehicle, the correction should be performed to increase the individual risk.

Furthermore, group relationship determiner 24 may also determine, using the environmental information, whether the at least two second mobile bodies have the predetermined relationship. For example, based on the time and terrain information included in the environmental information and the determined positions and attributes, group relationship determiner 24 is able to determine that the plurality of second mobile bodies detected are students walking in line on the way to or from school. This allows risk corrector 25, described later, to perform the individual risk correction to reduce the individual risk. As a result, a more accurate risk can be calculated for each of the at least two second mobile bodies.

### 1.3.6 Risk Corrector 25

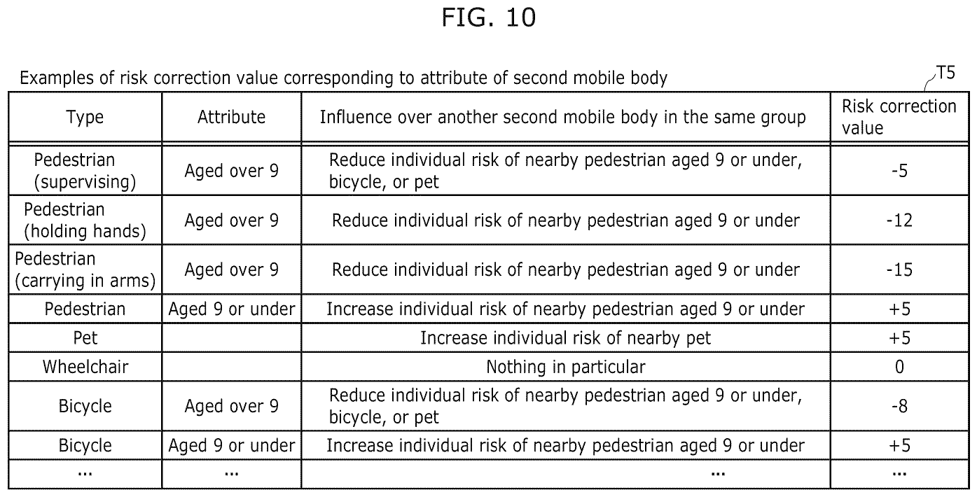

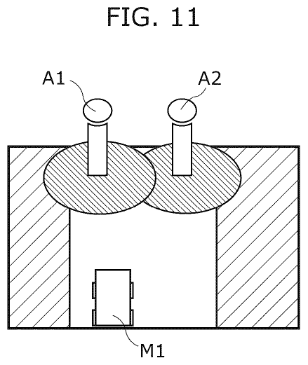

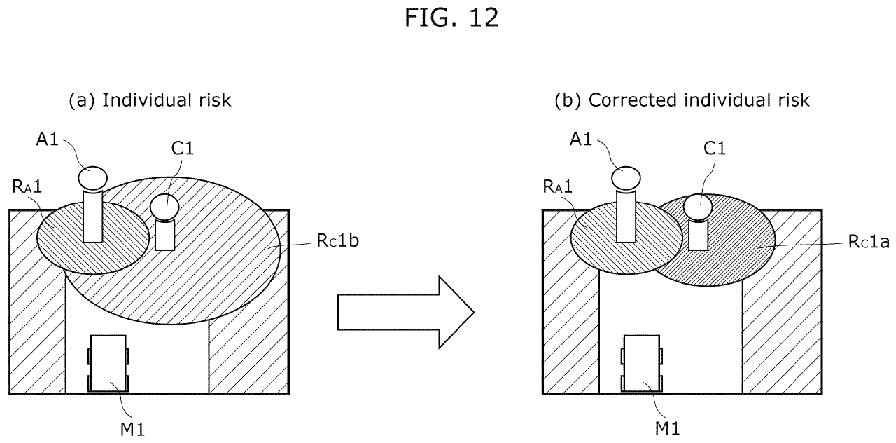

Risk corrector 25 corrects the individual risk calculated for each of the at least two second mobile bodies when the at least two second mobile bodies have the predetermined relationship. For example, risk corrector 25 may correct the individual risk calculated for each of the at least two second mobile bodies, with reference to a table that includes a type and an attribute of the second mobile body and a corresponding correction value (see table T5 illustrated in FIG. 10 for example). Here, the processor executes the predetermined program stored in the memory. This enables risk corrector 25 to perform the aforementioned correction function. Risk corrector 25 is an example of an executer.

To be more specific, when the at least two second mobile bodies detected are two second mobile bodies that are one person aged at least a predetermined age and one child under the predetermined age for example, risk corrector 25 may correct the individual risk as follows with reference to the table. More specifically, risk corrector 25 may perform the correction to reduce the individual risk calculated for the second mobile body that is the child who is one of the two second mobile bodies. In contrast, risk corrector 25 need not correct the individual risk calculated for the second mobile body that is the person aged at least the predetermined age who is the other of the two second mobile bodies.

When each of the at least two second mobile bodies detected is a young child under the predetermined age for example, risk corrector 25 may perform, with reference to the table, the correction to increase the individual risk calculated for each of the at least two second mobile bodies.

When the at least two second mobile bodies detected are one adult and at least two young children under the predetermined age for example, risk corrector 25 may correct the individual risks as follows with reference to the table. More specifically, risk corrector 25 may perform the correction to reduce the individual risk calculated for each of the at least two second mobile bodies that are the at least two children included among the at least two second mobile bodies. In contrast, risk corrector 25 need not correct the individual risk calculated for the second mobile body that is the adult included among the at least two second mobile bodies. Note that a reduction from the individual risk calculated for each of the at least two children in the group of the one adult and the at least two children may be smaller than a reduction from the individual risk calculated for one child in a group of one adult and the one child. When one adult watches over two children, the risk can be lower than when a child is all alone. However, it is still harder for one adult to watch over two children than to watch over one child. This is because the risk to one child when one adult watches over two children can be higher than the risk to one child when one adult watches over this one child.

FIG. 10 is a diagram illustrating examples of a risk correction value according to the present embodiment.

Table T5 in FIG. 10 shows an example of a risk correction value corresponding to the type and attribute of the second mobile body. Note that although the risk correction value is determined corresponding to the type and attribute of the second mobile body in FIG. 10, this is not intended to be limiting. For example, the risk correction value may be determined based on the positional relationship between first mobile body M1 and a corresponding one of the at least two second mobile bodies. In this case, a table indicating the risk correction value corresponding to such a positional relationship is generated beforehand.

In the present embodiment, when group relationship determiner 24 determines that the plurality of second mobile bodies belong to a group, risk corrector 25 performs individual risk correction (risk correction) to reflect an influence of a different second mobile body belonging to the group. For example, when group relationship determiner 24 determines that the plurality of second mobile bodies belong to the group, risk corrector 25 corrects, with reference to table T5 illustrated in FIG. 10, the individual risks calculated by individual risk calculator 23.

Here, suppose that the plurality of second mobile bodies belong to a group of a parent who is a pedestrian aged 30 and a child who is a pedestrian aged 5 and that the pedestrian aged 30 is not holding the hand of the pedestrian aged 5 nor carrying the pedestrian aged 5 in the arms. In this case, the individual risk of the pedestrian aged 30 is calculated at the risk value of “5” corresponding to the pedestrian aged over 9, with reference to table T1 illustrated in FIG. 5A, and the risk correction is not performed on this risk value. On the other hand, the individual risk of the pedestrian aged 5 is calculated at the risk value of “15” corresponding to the pedestrian aged 9 or under with reference to table T1 illustrated in FIG. 5A. Then, this individual risk is calculated at the individual risk of “10” as a result of the correction performed according to the risk correction value “−5” corresponding to the pedestrian (supervising) aged over 9 with reference to table T5 illustrated in FIG. 10.

Next, the individual risk corrected when the plurality of second mobile bodies have the predetermined relationship is described with reference to FIG. 11 to FIG. 14.

Each of FIG. 11 to FIG. 14 is a conceptual diagram illustrating an example of the risk correction reflecting an influence of a different second mobile body in the same group according to the present embodiment.

FIG. 11 illustrates an example case where the risk correction is not performed when second mobile body A1 and second mobile body A2 are both adult pedestrians and belong to a group. The individual risks of the adult pedestrians are assumed not to be affected by each other's influence. Thus, when second mobile body A1 and second mobile body A2, both adult pedestrians, have the predetermined relationship and belong to the group, risk corrector 25 does not perform the risk correction on the calculated individual risks.

Note that risk corrector 25 may perform the risk correction on the calculated individual risks even for a group of adult pedestrians, depending on the attributes and states of the adult pedestrians. Examples of the attributes in such a case include a high school student and a college student. Examples of the state include a drunk state. For example, when adult pedestrians seem to be fooling around for fun, risk corrector 25 may perform the correction to increase the individual risk. Risk corrector 25 may perform this correction with reference to a table that associates the attributes or states of the adult pedestrians in the group with a risk correction value. Here, risk corrector 25 may perform the correction to increase the individual risk of one of the adult pedestrians, or the individual risks of both of the adult pedestrians. Whether the adult pedestrian is a high school student, a college student, or drunk is obtainable through image analysis performed on the image, for example.

FIG. 12 illustrates an example case where, when second mobile body A1 who is an adult pedestrian and second mobile body C1 who is a child pedestrian belong to a group, the risk correction is performed only on the individual risk of second mobile body C1. In (a) of FIG. 12, the calculated individual risks of second mobile body A1 and second mobile body C1 are indicated by the respective sizes of area R_{A}1 and area R_{C}1b. Each of area R_{A}1 and area R_{C}1b indicates a corresponding range for first mobile body M1 to issue an alert to avoid danger, for example. The size of the range increases as the risk increases. In (b) of FIG. 12, area R_{C}1b indicating the individual risk is corrected to area R_{C}1a as a result of the risk correction performed to reduce the individual risk of second mobile body C1. This is because, in the group of one adult and one child, this adult watches over the child to reduce dangerous behavior of the child and thus the risk of this child can be lower than the risk individually calculated for one child.

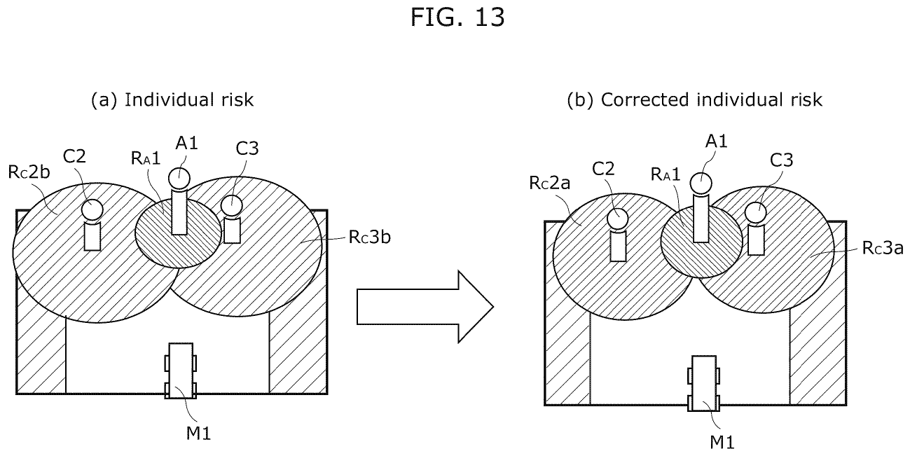

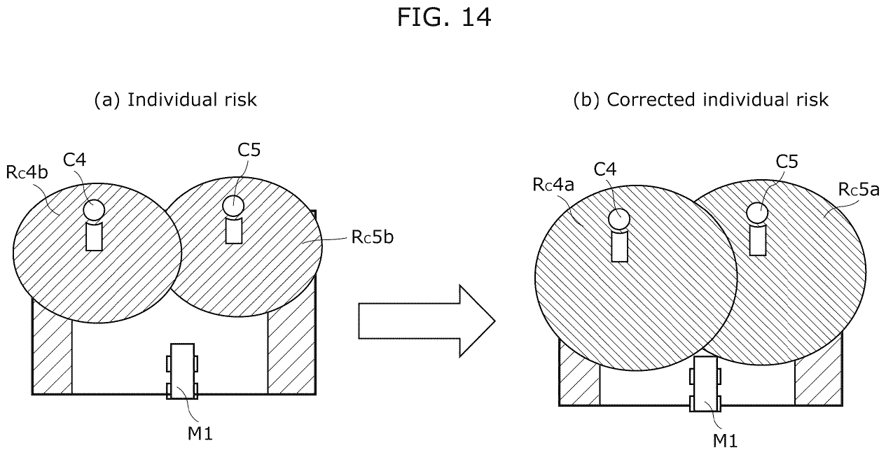

FIG. 13 illustrates an example case where, when second mobile body A1 who is an adult pedestrian and second mobile bodies C2 and C3 each of whom is a child pedestrian belong to a group, the risk correction is performed only on the individual risks of second mobile bodies C2 and C3. In (a) of FIG. 13, the calculated individual risks of second mobile body A1, second mobile body C2, and second mobile body C3 are indicated by the respective sizes of area R_{A}1, area R_{C}2b, and area R_{C}3b. In (b) of FIG. 13, area R_{C}2b and area R_{C}3b indicating the individual risks are corrected to area R_{C}2a and area R_{C}3a as a result of the risk correction performed to reduce the individual risks of second mobile body C2 and second mobile body C3. This is because, in the group of one adult and two children, this adult watches over the children to reduce dangerous behavior of the children and thus the risks of these children can be lower than the risk individually calculated for one child. However, as compared to when one adult watches over one child, dangerous behavior of the children cannot be reduced. Thus, although each of the risks of the two children is lower than the risk individually calculated for one child alone, each of the risks of the two children is higher than the risk of one child alone watched over by one adult.

FIG. 14 illustrates an example case where, when second mobile body C4 and second mobile body C5 each of whom is a child pedestrian belong to a group, the risk correction is performed on the individual risks of second mobile body C4 and second mobile body C5. In (a) of FIG. 14, the calculated individual risks of second mobile body C4 and second mobile body C5 are also indicated by the respective sizes of area R_{C}4b and area R_{C}5b. In (b) of FIG. 14, area R_{C}4b and area R_{C}5b indicating the individual risks are corrected to area R_{C}4a and area R_{C}5a as a result of the risk correction performed to increase the individual risks of second mobile body C4 and second mobile body C5. This is because, in the group of two children with no adults, dangerous behavior of the children is highly likely to be compounded and thus the risks of these children can be higher than the risk individually calculated for each of the two children.

Note that even when second mobile body C4 and second mobile body C5 each of whom is a child pedestrian belong to a group, the individual risks of second mobile body C4 and second mobile body C5 need not be corrected. For example, for the group of second mobile bodies each of whom is a child pedestrian, whether to correct the individual risks may be set for each of the determination criteria illustrated in FIG. 7. Alternatively, for the group of second mobile bodies each of whom is a child pedestrian, setting for whether to correct the individual risks may be received beforehand and risk corrector 25 may uniformly perform this set control.

### 1.3.7 Information Generator 26

Based on the individual risk corrected by risk corrector 25, information generator 26 generates at least one of control information for controlling first mobile body M1 or notice information for providing notice to the remote supervisor who remotely supervises or operates first mobile body M1. Here, the processor executes the predetermined program stored in the memory. This enables information generator 26 to perform the generation function.

For example, according to the corrected individual risk value, information generator 26 may generate, as the control information, information for causing first mobile body M1 to perform at least one of: control for making a temporary stop; control for performing an avoidance action; control for calling attention using speech; or control for turning a light on. After this, information generator 26 may also generate, as the control information, information for causing first mobile body M1 to perform control for resuming traveling. For example, according to the corrected individual risk value, information generator 26 may generate, as the notice information, alert information indicating an alert that encourages the remote supervisor to pay close attention to first mobile body M1 or to operate first mobile body M1. Here, the notice information may include information indicating at least one of: the size of alert display indicating the alert; the color of the alert display; whether to flash the alert display; the volume level of notice sound for the alert; or the sound pitch of the notice sound.

In the present embodiment, information generator 26 determines the details of control over terminal D1 and first mobile body M1, based on the individual risk corrected by risk corrector 25. Depending on circumstances, the control details may include only the control information for first mobile body M1, include only the control information and the notice information for terminal D1, or include the control information, the notice information for terminal D1, and so on.

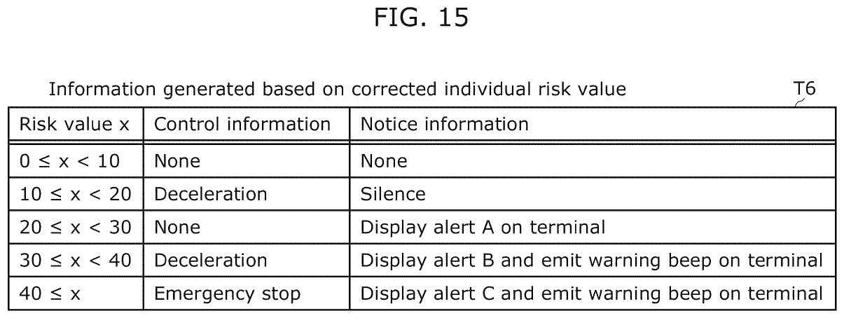

FIG. 15 is a diagram illustrating an example of information generated based on the corrected individual risk value according to the present embodiment. Table T6 illustrated in FIG. 15 is an example of information in which a risk is associated with control details.

As an example of the information in which a risk is associated with control details, table T6 in FIG. 15 shows a combination of control information and notice information that are generated based on a corrected individual risk value, together with details of the control information and the notice information. To be more specific, as illustrated in FIG. 15, when the corrected individual risk value is 0 to 9 for example, information generator 26 does not generate the control information nor the notice information with reference to table T6. When the corrected individual risk value is 10 to 19, information generator 26 generates the control information for causing first mobile body M1 to decelerate and also generates the notice information that is silent for terminal D1. When the corrected individual risk value is 20 to 29, information generator 26 generates only the notice information that includes an instruction for causing terminal D1 to display alert A. When the corrected individual risk value is 30 or greater, information generator 26 generates both the control information for first mobile body M1 and the notice information for terminal D1.

Note that the notice information for terminal D1 may include instruction information for ordering at least one of: rendering details; alert display, such as flashing of an object; activation or deactivation of buttons; or sound output.

Furthermore, the control information for first mobile body M1 may include information for causing first mobile body M1 to perform at least one of: speed control; steering control; video display control; or sound out control. The control information may also be generated based on information other than the corrected individual risk. For example, when information indicating that a staff member who operates first mobile body M1 is approaching has been obtained, information generator 26 may generate, even for the corrected individual risk with a high value, only the control information for first mobile body M1 without including the instruction information for instructing terminal D1 to display the alert for instance.

Furthermore, information generator 26 may generate the instruction information for instructing terminal D1 to display the alert by reflecting not only the individual risk corrected by risk corrector 25 but also the situation of the group to which the at least two second mobile bodies belong. For example, to notify the remote supervisor of the situation of the group to which the at least two second mobile bodies belong, information generator 26 may generate the instruction information for ordering the alert display saying “Pedestrian group is approaching” or “Parent and child holding hands are approaching”, for example.

For a group of an adult and a young child in particular, the remote supervisor needs to watch such a group carefully because it can be hard to see this adult and this child as a group on the screen when, depending on the timing to look at the screen, the child is hidden behind the adult for example. The notice by the alert allows the remote supervisor to know there are a plurality of persons, and thus keeps the remote supervisor from overlooking the young child in the above case.

Note that the alert display may include a recognizable indication of belonging to the same group. For example, the alert display may include an indication that emphasizes the group of the at least two second mobile bodies. The alert display may include, as the indication, one rectangle that encloses all the members of this group. Alternatively, respective frames indicating the members of this group may be shown in the same style of presentation. Here, each of the levels of the individual risks is different depending on a reason for being determined to belong to the same group. Thus, the style of presentation may be different for each frame according to the reason for being determined to belong to the same group or according to the level of the risk corresponding to the reason for the determination. The style of presentation of the frame includes at least one of: a style of frame border; or a color indicating the group. Furthermore, the alert display may be a simple indication of the reason for the determination, the risk level, or the like superimposed on the screen. For example, particularly when a young child is determined to belong to a group because of a physical connection such as holding hands with the parent or being carried in the arms of the parent, the risk that the child is approaching is reduced. In contrast, when a young child having no physical connection with anybody is determined to belong to a group because of a short distance, the risk that the child is approaching is not so low. Thus, the remote supervisor needs to pay more attention to the latter case than the former case. On this account, the alert display may be more emphasized in the latter case than the former case.

Furthermore, the alert display may be performed when the situation of the group changes. For example, when the physical connection is no longer present in the group and the distance from the group is shorter, more attention needs to be paid. In such a case, the alert display is effective. In an opposite case, the alert display is not performed. Alternatively, the level of emphasis on the alert display is lowered to reduce the man-hours of the remote supervisor to pay attention. This allows the remote supervisor to spend man-hours to pay attention elsewhere. The alert display may be provided in a way that permits a distinction between an alert that encourages more attention and an alert that allows the reduction of the man-hours needed to pay attention. Examples of such a way include, but not limited to, changing display colors. Varying the presentation of the alert display is an example of executing a predetermined operation.

Furthermore, the alert display may include an indication of an attribute of the group or an indication of the number of second mobile bodies included in the group. Examples of the attribute of the group include, but not limited to, parent-and-child, adult-and-adult, child-and-child, a pair of persons in wheelchair and person pushing wheelchair, person-and-pet.

When the image shows a moment in time when the child is just behind the adult, it is hard even for the computer to determine a group. Thus, when the computer determined the group a predetermined period of time before, information generator 26 may assume that the group is present even when the current image shows only one adult because the child is just behind the adult for example. Then, the alert display indicating the presence of a group may be performed. For example, information generator 26 may include, in the alert display, information indicating that someone in the group is invisible on the screen (such as an indication saying “Child in blind spot”). Moreover, information generator 26 may include, in the alert display, the number of persons that are invisible, for example.

Furthermore, information generator 26 may generate the control information for first mobile body M1 by placing priority on the situation of the group of the at least two second mobile bodies over the individual risk corrected by risk corrector 25. For example, suppose that a teacher and a plurality of children led by the teacher belong to a group. In this case, although the risk value indicates that an alert or control over first mobile body M1 is needed, the group led by the teacher can be safe. Thus, when the corrected individual risk is a predetermined value at most, information generator 26 need not generate the control information for first mobile body M1.

### 1.3.8 Outputter 27

Outputter 27 outputs at least one of the control information or the notice information generated by information generator 26.

In the present embodiment, outputter 27 transmits the control details determined by information generator 26, or more specifically, at least one of the control information or the notice information generated by information generator 26, to terminal D1 via communicator 11. Note that information generator 26 is also able to transmit the control details determined by information generator 26 to first mobile body M1.

### 2 Operation

An information processing method executed by information processing device 10 having the configuration described above, or more specifically, an operation performed by information processing device 10 is described as follows.

### 2.1 Operation of Overall Structure

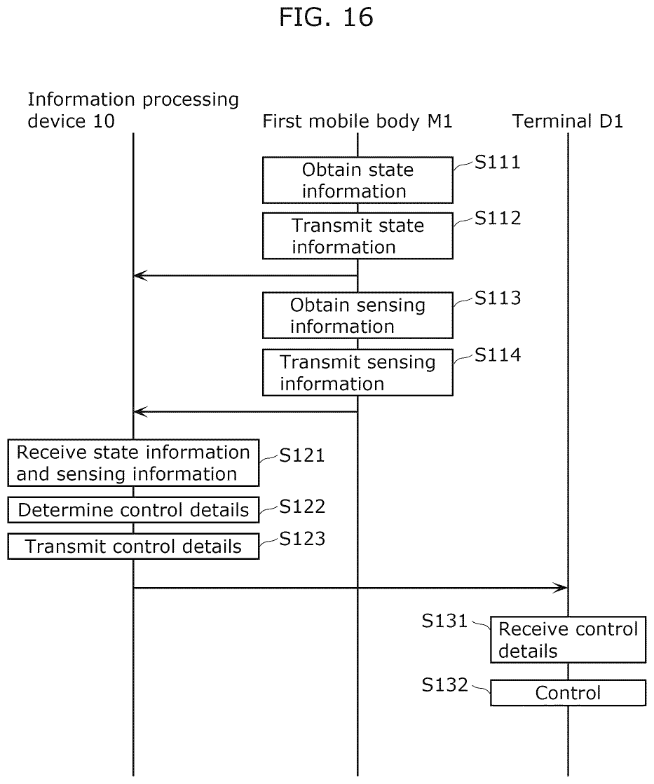

Information transmission among information processing device 10, first mobile body M1, and terminal D1 is first described with reference to FIG. 16.

FIG. 16 is a sequence diagram illustrating an operation of the overall structure including information processing device 10 according to the present embodiment. FIG. 16 illustrates an example of a sequence performed when first mobile body M1 transmits the state information and the sensing information to information processing device 10 and then terminal D1 performs control based on the control details determined by information processing device 10.

State information obtaining device M13 of first mobile body M1 obtains the state information (S111). Then, communication device M11 of first mobile body M1 transmits the obtained state information to information processing device 10 via network N (S112).

Next, sensing device M12 of first mobile body M1 obtains the sensing information (S113). Then, communication device M11 of first mobile body M1 transmits the obtained sensing information to information processing device 10 via network N (S114). Note that the state information and the sensing information may be transmitted at the same time or at different times. Moreover, the frequency at which the state information is obtained and transmitted may be different from the frequency at which the sensing information is obtained and transmitted.

Next, receiving the state information and the sensing information via network N (S121), information processing device 10 performs information processing using the received state information and the received sensing information and then determines the control details (S122). Note that the information processing is described in detail later.

Next, information processing device 10 transmits the determined control details to terminal D1 via network N (S123).

Next, when communication device D11 of terminal D1 receives the control details (S131), terminal D1 performs control based on the received control details (S132).

Here, besides the case where only terminal D1 performs the control based on the control details as illustrated as an example in FIG. 16, the control details may be transmitted only to first mobile body M1 and only first mobile body M1 may perform the control, depending on the control details determined in Step S122. Moreover, the control details may be simultaneously transmitted to both terminal D1 and first mobile body M1, and both terminal D1 and first mobile body M1 may perform the respective controls. Furthermore, the control details may not be transmitted to terminal D1 and first mobile body M1, and terminal D1 and first mobile body M1 may not perform the control.

Although FIG. 16 shows a case where one terminal D1 and one first mobile body M1 are present, a plurality of terminals D1 and a plurality of first mobile bodies may be present. In this case, the remote supervisor may perform control on a specific terminal D1 included among the plurality of terminals D1. When a plurality of remote supervisors are present, the control may be performed on all the terminals D1.

### 2.2 Operation of Information Processing Device 10

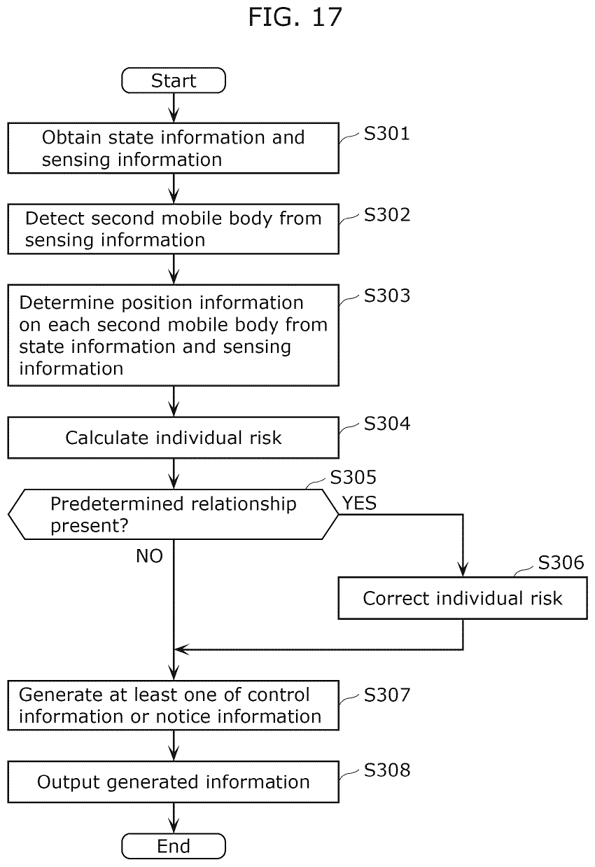

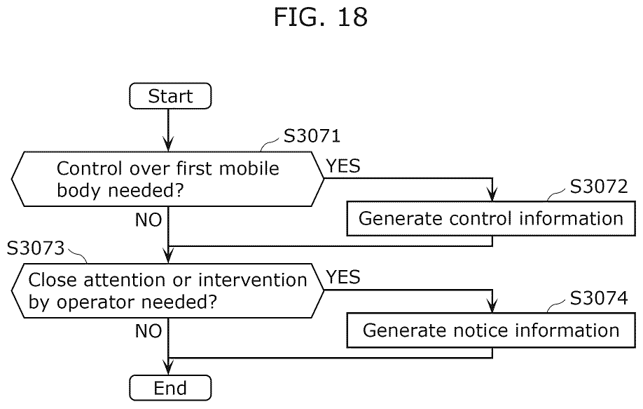

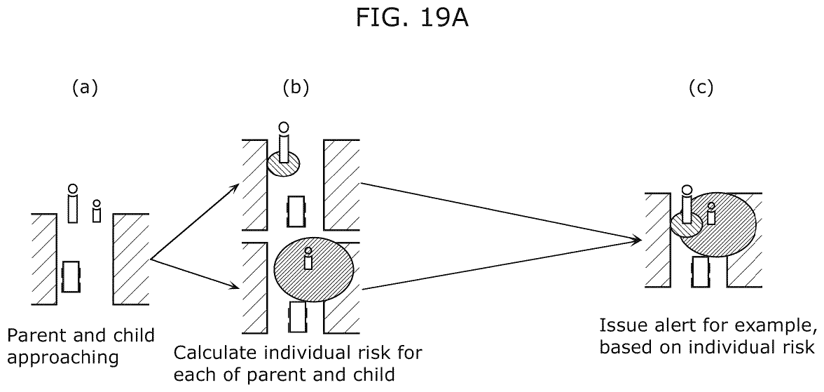

Next, an example of the operation performed in Steps S121 to S123 by information processing device 10 is described with reference to FIG. 17 and FIG. 18.

FIG. 17 is a flowchart illustrating an example of the operation (the information processing method) performed by information processing device 10 according to the present embodiment. FIG. 17 shows an example of processing performed by processor 20 of information processing device 10 according to the present embodiment.

As illustrated in FIG. 17, information processing device 10 first obtains the state information and the sensing information (S301). In the present embodiment, communicator 11 of information processing device 10 receives, via network N: the sensing information that is video information obtained by sensing device M12, such as an in-vehicle camera, of first mobile body M1; and the state information obtained by state information obtaining device M13 of first mobile body M1. Note that the state information may include information on first mobile body M1, such as position information, speed information, angle information, direction information, and display detail information.

Next, information processing device 10 detects a second mobile body from the sensing information obtained in Step S301 (S302). In the present embodiment, second-mobile-body detector 21 of information processing device 10 detects at least two second mobile bodies by image recognition using the obtained video information and information needed to detect the second mobile bodies. Note that a second mobile body included among the at least two second mobile bodies may be a pedestrian; a person riding on a conveyance, such as a bicycle, a wheelchair, a stroller, or a mobility scooter for seniors; or a pet, for example.

Next, information processing device 10 determines the position information for each of the second mobile bodies from the state information and the sensing information obtained in Step S301 (S303). In the present embodiment, second-mobile-body position determiner 22 of information processing device 10 calculates position coordinates of the second mobile body with respect to first mobile body M1 using the obtained state information and the position information on the detected second mobile body on the image. Note that when the state information includes the position coordinates and direction of first mobile body M1, the position information on the camera, the tilt of the camera, and the field of view of the camera, second-mobile-body position determiner 22 may calculate the position coordinates of the second mobile body using these pieces of information included in the state information. Furthermore, second-mobile-body position determiner 22 may calculate speed information and acceleration information on the second mobile body with respect to first mobile body M1, based on temporal changes in the calculated position information on the second mobile body.

Next, information processing device 10 calculates an individual risk for each of the second mobile bodies, based on the state information obtained in Step S301 and the position coordinates determined in Step S303 (S304). In the present embodiment, individual risk calculator 23 of information processing device 10 calculates the individual risk for each of the second mobile bodies. Individual risk calculator 23 may calculate the individual risk for each of the second mobile bodies, by checking the attribute of the second mobile body determined in Step S302 and the position information, the speed information, and the acceleration information obtained in Step S303 against the reference information for the risk calculation.

Here, an example of calculating the individual risk with reference to tables T1 to T4 illustrated in FIG. 5A to FIG. 5D is described. For example, the individual risk is calculated for each of two second mobile bodies, one of whom is an adult pedestrian aged over 9 and the other of whom is a child pedestrian aged 9 or under. In this case, individual risk calculator 23 can calculate the risk value of the pedestrian aged over 9 at “3” and the risk value of the pedestrian aged 9 or under at “15” with reference to table T1 of FIG. 5A. Furthermore, when the distance between the two second mobile bodies and first mobile body M1 that is a vehicle is 3 m for example, individual risk calculator 23 can calculate each of the risk values of the two second mobile bodies at “5” with reference to table T2 of FIG. 5B. Furthermore, when the traveling speed of first mobile body M1 included in the state information is 3 km/h, individual risk calculator 23 can calculate each of the risk values of the two second mobile bodies at “3” with reference to table T3 of FIG. 5C. Furthermore, when the speed of the two second mobile bodies is 7 km/h for example, individual risk calculator 23 can calculate each of the risk values of the two second mobile bodies at “8” with reference to table T4 of FIG. 5D. Then, individual risk calculator 23 calculates the individual risk by combining these risk values. Here, the description is continued by referring back to FIG. 17.

Next, information processing device 10 determines whether the at least two second mobile bodies have a predetermined relationship (S305). In the present embodiment, when information processing device 10 detects a plurality of second mobile bodies, group relationship determiner 24 determines whether the plurality of second mobile bodies belong to a group by determining whether the plurality of second mobile bodies have a predetermined relationship. For example, group relationship determiner 24 may determine a group of the plurality of second mobile bodies and members of the group. Then, group relationship determiner 24 may determine whether the plurality of second mobile bodies belong to the group, based on the group determination information held in storage 12, the determined attributes of the second mobile bodies, and the calculated position information on the second mobile bodies with respect to first mobile body M1, for example.

Here, a specific example is described where it is determined that the at least two second mobile bodies have the predetermined relationship. Suppose that the at least two second mobile bodies include one adult and at least one child, for example. Then, based on the position information determined in Step S303, it can be identified that the adult and the child are standing within a certain distance of each other for at least a certain period of time or that the adult and the child within a certain distance of each other are traveling in the same direction substantially at the same speed. In this case, group relationship determiner 24 can determine that the at least two second mobile bodies have the predetermined relationship and belong to a group. Furthermore, suppose that a situation where physical restraint is present can be identified from the video information. Examples of this situation include when an adult is holding hands with a child, when an adult is carrying a child in the arms, or when a dog is connected by a leash to a person. In this case, group relationship determiner 24 can determine that the at least two second mobile bodies have the predetermined relationship and belong to a group. Furthermore, suppose that a situation where there are persons one of whom is looking at the other and the other is being looked at can be identified from the video information. Examples of this situation include when a person is looking at another person for at least a certain period of time, such as when an adult is watching over a child or when persons are looking at each other. In this case, group relationship determiner 24 can determine that the at least two second mobile bodies including the person looking at the other person and the other person being looked at have the predetermined relationship and belong to a group. Furthermore, suppose that a situation where persons are talking to each other can be identified from the sound information on the surroundings of first mobile body M1 included in the state information. Examples of this situation include when an adult is talking to a child and when a parent and a child are having a conversation. In this case, group relationship determiner 24 can determine that the at least two second mobile bodies talking to each other have the predetermined relationship and belong to a group.

When it is determined in Step S305 that the plurality of second mobile bodies do not have a predetermined relationship and do not belong to a group (NO in S305), information processing device 10 proceeds to Step S307.

In contrast, when it is determined in Step S305 that the plurality of second mobile bodies have the predetermined relationship and belong to a group (YES in S305), information processing device 10 corrects the individual risks calculated in Step S304 (S306). For example, risk corrector 25 of information processing device 10 corrects the individual risk for each of the second mobile bodies determined to belong to the group in Step S305. To be more specific, risk corrector 25 corrects (performs the risk correction on) the individual risk calculated for each of the plurality of second mobile bodies by individual risk calculator 23 to reflect an influence of a different second mobile body belonging to the same group.

Here, an example of correcting the individual risk with reference to table T5 illustrated in FIG. 10 is described. For example, suppose that it is determined that two second mobile bodies one of whom is a pedestrian aged 30 and the other of whom is a child pedestrian aged 5 belong to a group. Also suppose that the individual risk of the pedestrian aged 30 is calculated at “3” and the individual risk of the child aged 5 is calculated at “15”, with reference table T1 of FIG. 5A. Even in this case, as illustrated in table T5 of FIG. 10, the risk correction value for the individual risk is different depending on the situation of the two second mobile bodies belonging to the group, or more specifically, depending on whether the pedestrian aged over 9 is: watching over the other mobile body; holding hands with the other mobile body; or carrying the other mobile body in the arms.

When the situation of the parent and the child belonging to the group is that the parent is watching over the child for example, risk corrector 25 can obtain the risk correction value “−5” corresponding to the pedestrian aged over 9 with respect to the other second mobile body with reference to table T5 illustrated in FIG. 10. Thus, by correcting the individual risk “+15” of the child with the risk correction value “−5”, risk corrector 25 can calculate the corrected individual risk at “+10”. Furthermore, when the situation of the parent and the child belonging to the group is that the parent is holding hands with the child for example, risk corrector 25 can obtain the risk correction value “12” corresponding to the pedestrian aged over 9 with respect to the other second mobile body with reference to table T5 illustrated in FIG. 10. Thus, by correcting the individual risk “+15” of the child with the risk correction value “−12”, risk corrector 25 can calculate the corrected individual risk at “+3”. Furthermore, when the situation of the parent and the child belonging to the group is that the parent is carrying the child in the arms for example, risk corrector 25 can obtain the risk correction value “−15” corresponding to the pedestrian aged over 9 with respect to the other second mobile body with reference to table T5 illustrated in FIG. 10. Thus, by correcting the individual risk “+15” of the child with the risk correction value “−15”, risk corrector 25 can calculate the corrected individual risk at “+0”.

On the other hand, when the situation of the parent and the child belonging to the group is that the parent is watching over the child, no risk correction value is provided corresponding to the pedestrian aged 9 or under with respect to the other second mobile body. Thus, risk corrector 25 does not correct the individual risk “3” of the parent. Alternatively, by correcting the individual risk “+3” of the parent with the risk correction value “9”, risk corrector 25 can calculate the corrected individual risk at “+3”.

Note that the situation of the at least two second mobile bodies changes over time. For this reason, Step S305 and Step S306 may be repeated periodically to update the corrected individual risk. For example, when the parent and the child who were holding hands with each other let go of each other's hand, the change in the situation of the group of the two second mobile bodies is detected through, for example, image recognition. This causes the risk correction value obtained from table T5 of FIG. 10 to change. As a result, the corrected individual risk value also changes.

Furthermore, suppose for example that it is determined that four second mobile bodies one of whom is a pedestrian aged 30 and the other three of whom are child pedestrians aged 5 belong to a group. Also suppose that the individual risk of the pedestrian aged 30 is calculated at “3” and each of the individual risks of the children aged 5 is calculated at “15”, with reference to table T1 of FIG. 5A. In this case, as the risk correction values for each of the children, the risk correction value “−5” corresponding to the pedestrian aged over 9 with respect to the other second mobile bodies and the risk correction value “+10” (this value is calculated by “5”*“2”) corresponding to the two pedestrians aged 9 or under with respect to the other mobile body can be obtained, with reference to table T5 of FIG. 10. Thus, by correcting the individual risk “+15” of each of the children with the risk correction value “+5” (this value is calculated by “−5”+“10”), risk corrector 25 can calculate the corrected individual risk at “+20” for each of the children. Here, the description is continued by referring back to FIG. 17.

Note that although risk corrector 25 does not correct the individual risk of the parent in the above example, this is not intended to be limiting and the individual risk of the parent may also be corrected. For example, suppose that the situation of a parent and a child belonging to a group is that the parent is watching over the child. Here, the risk correction value corresponding to the child with respect to the other second mobile body (the parent, in this case) may be included in table T5. Thus, risk corrector 25 may correct the individual risk of the parent with reference to table T5. For example, when the situation of a parent and a child belonging to a group is that the parent is watching over the child, risk corrector 25 may perform the correction to increase the individual risk of the parent.

Next, based on the individual risk corrected in Step S306, information processing device 10 generates at least one of the control information for controlling first mobile body M1 or the notice information for providing notice to the remote supervisor who remotely supervises or operates first mobile body M1 (S307). For example, based on the individual risk corrected in Step S306, information generator 26 of information processing device 10 determines the details of control over terminal D1 and first mobile body M1. In the present embodiment, information generator 26 is able to determine the control details based on the uncorrected individual risk or the corrected individual risk, with reference to the information in which a risk is associated with control details as illustrated in FIG. 15 for example.

Here, an example of determining the control details with reference to table T6 illustrated in FIG. 15 is described. For example, suppose that a pedestrian aged 30 and three child pedestrians aged 5 belong to a group, and that the corrected individual risk of each of the child pedestrians is “20”. In this case, information generator 26 determines the control details with reference to table T6 of FIG. 15. Thus, information generator 26 does not generate the control information for first mobile body M1 and generates the notice information for causing terminal D1 to display alert A.

Next, information processing device 10 outputs at least one of the control information or the notice information generated in Step S307 (S308). For example, outputter 27 of information processing device 10 transmits, from communicator 11, the control information determined by information generator 26 in Step S307.

FIG. 18 is a flowchart illustrating an example of details of Step S307 illustrated in FIG. 17.

In Step S307, information processing device 10 first determines whether control over first mobile body M1 is necessary (S3071). For example, based on the individual risk corrected in Step S306, information generator 26 of information processing device 10 is able to determine whether the control over first mobile body M1 is necessary, with reference to the information, held by storage 12, in which a risk is associated with control details.

When it is determined in Step S3071 that the control over first mobile body M1 is necessary (YES in S3701), information generator 26 generates the control information (S3072).

In contrast, when it is determined in Step S3071 that the control over first mobile body M1 is not necessary (NO in S3701), information generator 26 determines whether first mobile body M1 requires close attention or intervention by the operator (remote supervisor) (S3037). For example, based on the individual risk corrected in Step S306, information generator 26 of information processing device 10 is able to determine whether first mobile body M1 requires close attention or intervention by the operator, with reference to the information, held by storage 12, in which a risk is associated with control details.

When it is determined in Step S3037 that the close attention or intervention by the operator is required (YES in S3037), information generator 26 generates the notice information (S3074).

In contrast, when it is determined in Step S3037 that the close attention or intervention by the operator is not required (NO in S3037), the process of Step S307 is ended.

### 3. Advantageous Effects etc.

The information processing method according to the present embodiment is capable of calculating a more accurate risk for a mobile body, such as a pedestrian, and then performing necessary and sufficient control on a mobile body, such as a vehicle. To be more specific, for second mobile bodies having a predetermined relationship and belonging to a group, the present embodiment enables more accurate risk assessment by performing risk correction according to the situation of the group. Furthermore, the transmission of the alert notice to terminal D1 or the control over first mobile body M1 based on the accurate risk assessment can reduce the number of interventions by the remote supervisor and thus also reduce the load on the remote supervisor.

A concept of an individual risk calculated and corrected when a parent and a child are approaching the front of a vehicle is described according to a comparison example.

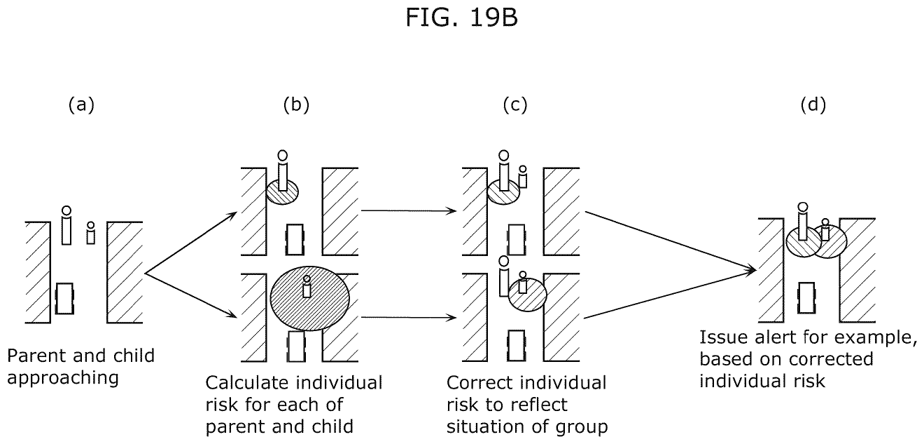

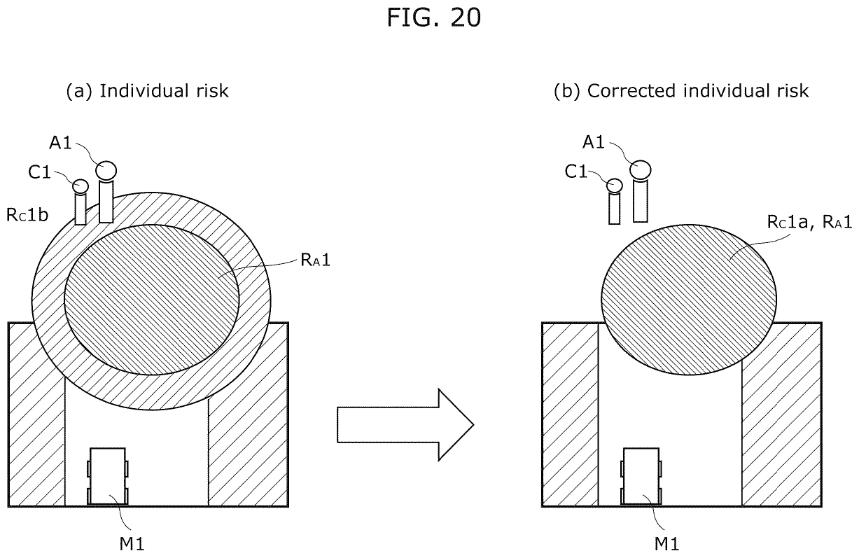

FIG. 19A is a conceptual diagram illustrating a risk calculated for a situation by a method according the comparison example. FIG. 19B is a conceptual diagram illustrating a risk calculated for a situation by the method according the present disclosure. Each of the examples in (a) of FIG. 19A and (a) of FIG. 19B illustrates a situation where a parent and a child are approaching the front of the vehicle. Each of the examples in (b) of FIG. 19A and (b) of FIG. 19B illustrates the calculated individual risks of the parent and the child that are indicated by the respective sizes of the areas. Each of the sizes of the areas indicates a corresponding range in which the vehicle should issue an alert to avoid danger. The size of the range increases as the individual risk increases. To be more specific, the individual risks are calculated to indicate that the risk of the parent who is an adult is smaller and that the risk of the child is larger.

In (c) of FIG. 19A, the vehicle is issuing an alert for example, based on the calculated individual risks as in (b) of FIG. 19A. In the comparison example, the relationship between the adult and the child is not reflected. More specifically, although the risk of the child who is being watched over by the parent (adult) in the parent-child group can be estimated smaller than the risk of a child who is alone, this is not reflected. As a result, unnecessary control is performed on the vehicle and this may result in a decrease in the vehicle operating efficiency.

In contrast, (c) of FIG. 19B indicates that the calculated individual risks as in (b) of FIG. 19B are corrected by reflecting the situation of the parent-child group. Then, in (d) of FIG. 19B, the vehicle is issuing an alert for example, based on the corrected individual risks as in (c) of FIG. 19B.

Even in the same situation where the parent and the child are approaching the front of the vehicle, the individual risk calculated for the child is different between (d) of FIG. 19B and (c) of FIG. 19A. More specifically, for the child belonging to the group, the risk correction is performed according to the situation of the group in which the parent-child relationship is present and the child is being watched over by the parent. With this, the risk assessed more accurately (the corrected individual risk) can be obtained. Hence, necessary and sufficient control can be performed on a mobile body, such as a vehicle.

### Variations of Embodiment

The following describes variations of Embodiment with reference to FIG. 20 to FIG. 22. Note that the following mainly describes differences from Embodiment, and that the details identical or similar to Embodiment is simplified or omitted from the description.

Another example of correcting an individual risk when a plurality of second mobile bodies have a predetermined relationship is first described with reference to FIG. 20. FIG. 20 is a conceptual diagram illustrating an example of risk correction reflecting an influence of a different second mobile body in the same group according to the present variation.

FIG. 20 illustrates an example case where, when second mobile body A1 who is an adult pedestrian and second mobile body C1 who is a child pedestrian belong to a group, the risk correction is performed only on the individual risk of second mobile body C1. In (a) of FIG. 20, the calculated individual risks of second mobile body A1 and second mobile body C1 are indicated by the respective sizes of area R_{A}1 and area R_{C}1b. Each of area R_{A}1 and area R_{C}1b indicates a corresponding range for first mobile body M1 to issue an alert to avoid danger, for example. The size of the range increases as the risk increases. Here, second mobile body A1 and second mobile body C1 are close to each other, and area R_{C}1b includes area R_{A}1. Note that area R_{A}1 may include an area situated between second mobile body A1 and first mobile body M1. For example, area R_{A}1 need not include second mobile body A1. Furthermore, second mobile body A1 and second mobile body C1 may be within area R_{C}1b, for example.

In (b) of FIG. 20, area R_{C}1b indicating the individual risk is corrected to area R_{C}1a as a result of the risk correction performed to reduce the individual risk of second mobile body C1. This is because, in the group of one adult and one child, this adult watches over the child to reduce dangerous behavior of the child and thus the risk of this child can be lower than the risk individually calculated for one child. Here, area R_{C}1a is identical to area R_{A}1. Note that area R_{C}1a may be smaller than area R_{C}1b and include area R_{A}1.

When area R_{C}1b corresponding to the child pedestrian includes the whole of area R_{A}1 corresponding to the adult pedestrian as described above, the correction may be performed to make the corrected area R_{C}1a corresponding to the child pedestrian identical to area R_{A}1 corresponding to the adult pedestrian. In other words, area R_{C}1b may be corrected to cause no alert to be issued even when first mobile body M1 enters area R_{C}1b and cause an alert to be issued when first mobile body M1 enters area R_{A}1.

Next, an example is described where a correction degree (risk correction value) by which the risk is corrected varies according to a determination criterion satisfied when whether the plurality of second mobile bodies have the predetermined relationship (group determination) is determined. For example, the risk correction value illustrated in FIG. 10 may vary according to which determination is made as “YES” in FIG. 7. For example, table T5 illustrated in FIG. 10 may be set for each of the determination criteria illustrated in FIG. 7. Alternatively, risk corrector 25 may correct the risk correction value in table T5 illustrated in FIG. 10 accordingly depending on the determination criterion satisfied.

For example, when there is a physical connection (such as holding hands or carrying in the arms), safety is high. Thus, to obtain a smaller individual risk value as a result of the correction, the risk correction value may be corrected to be greater in a negative direction. Furthermore, when the distance between two second mobile bodies is within a predetermined distance of each other, safety is rather high. Thus, to obtain a smaller individual risk value as a result of the correction, the risk correction value may be corrected to be greater in a negative direction. The amount of correction of the risk correction value may be set according to the safety. For example, the two second mobile bodies having a physical connection are safer than the two second mobile bodies being within the predetermined distance of each other. Thus, a larger amount of correction may be set for the situation where a physical connection is present. For example, storage 12 may store a table in which the amount of correction of the risk correction value is associated with safety. In this case, the safety is set for each of the determination criteria illustrated in FIG. 7.

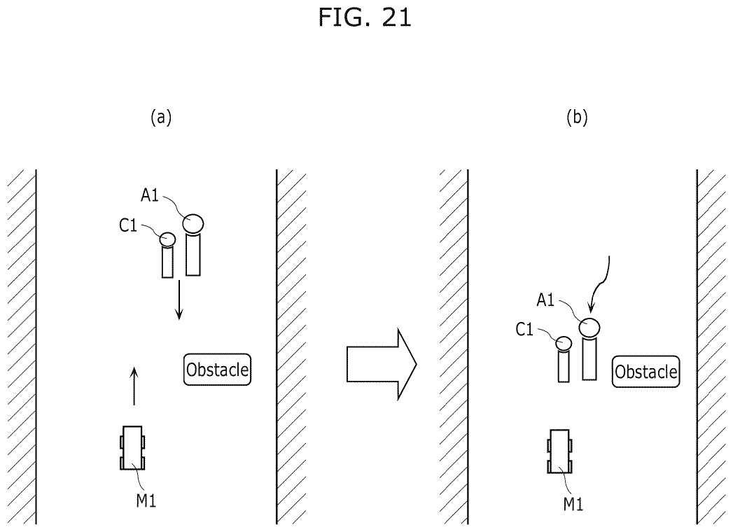

Next, an example where an utterance from first mobile body M1 to at least two second mobile bodies belonging to a group varies according to the relationship in the group determined through the group determination is described with reference to FIG. 21. The following describes an example where an utterance from first mobile body M1 to the group varies according to the relationship in the group. Note that varying the utterance is an example of executing the predetermined operation.

When the relationship in the group is an adult-child relationship for example, first mobile body M1 may issue an alert encouraging the adult to hold hands with the child. When the relationship in the group is an adult-adult relationship for example, first mobile body M1 may issue a normal alert (such as a voice saying “Vehicle is passing by”). Storage 12 may store a table in which a relationship is associated with a corresponding presentation of alert. Then, information generator 26 may generate the control information including the presentation of alert.

FIG. 21 is a diagram illustrating control performed on the first mobile body when two second mobile bodies having a predetermined relationship avoid an obstacle, according to the present variation. In (a) of FIG. 21, first mobile body M1 and two second mobile bodies A1 and C1 having the predetermined relationship are approaching each other, and an obstacle is present between first mobile body M1 and two second mobile bodies A1 and C1. In (b) of FIG. 21, first mobile body M1 is stationary to give the right of way to two second mobile bodies A1 and C1 avoiding the obstacle while passing by. Note that FIG. 21 illustrates a case where two second mobile bodies A1 and C1 are walking side by side (an example of traveling).

As illustrated in (b) of FIG. 21, when one second mobile body out of two second mobile bodies A1 and C1 avoids the obstacle, the other second mobile body also avoids the obstacle simultaneously. To be more specific, these two second mobile bodies may remain side by side when avoiding the obstacle. In this case, two second mobile bodies A1 and C1 approaches (or more specifically, jumps out toward) first mobile body M1.

In this case, two second mobile bodies A1 and C1 having the predetermined relationship may be regarded as one second mobile body, and a collision between this one second mobile body and the obstacle may be predicted based on their respective positions. Then, vehicle control may be performed on first mobile body M1 according to the result of the prediction. This vehicle control includes control for causing first mobile body M1 to stop. Furthermore, this vehicle control may also include control for causing first mobile body M1 to slow down or detour, for example.

For example, when the collision between the one second mobile body and the obstacle is predicted, information generator 26 may generate the control information that includes information for causing first mobile body M1 to stop in front of the obstacle. Such a process is performed for the at least two second mobile bodies having the predetermined relationship.

Note that although FIG. 21 illustrates the case where the two second mobile bodies having the predetermined relationship travel side by side, control may be performed to cause first mobile body M1 to stop when the two second mobile bodies travel one behind the other. An operation for causing first mobile body M1 to stop until the two second mobile bodies having the predetermined relationship have passed by the obstacle is an example of the predetermined operation.

Note that the present disclosure may be achieved by the following. More specifically, any process other than the processes described below need not be executed. Furthermore, the present disclosure may also be achieved by an information processing device that executes the information processing method described below or a program for causing a computer to execute the information processing method described below.

An information processing method executed by an information processing device includes: obtaining sensing information generated by imaging surroundings of a first mobile body that travels autonomously; detecting a second mobile body present in the vicinity of the first mobile body, based on the sensing information; determining, when the second mobile body detected in the vicinity of the first mobile body comprises at least two second mobile bodies, whether the at least two second mobile bodies have a predetermined relationship, based on the sensing information; and providing, when it is determined that the at least two second mobile bodies have the predetermined relationship, notice according to the predetermined relationship.

Next, display of support information (such as alert information) for performing remote supervisory control and paying close attention is described.

As described above as an example, information generator 26 generates the instruction information for ordering the alert display saying “Pedestrian group is approaching” or “Parent and child holding hands are approaching”, for example. However, the information processing method according to the present disclosure may be a method of generating instruction information for ordering alert display for at least two second mobile bodies according to a predetermined relationship of the at least two second mobile bodies, without correcting individual risks of the at least two second mobile bodies having the predetermined relationship. An operation of generating such instruction information is an example of the predetermined operation.

Next, an example of the aforementioned method of estimating an age is described. Note that the method of estimating the age is not limited to the method described below and any publicly known method can be used.

The age estimation is based on image recognition. To perform image recognition, the processor executes the predetermined program stored in the memory to perform image recognition through, for example, machine learning by deep learning and other AI technologies.

A first method is a method of estimating an age by facial recognition. When a person is not wearing a mask, a hat, sunglasses, or the like, the age of the person can be estimated with some degree of accuracy. A second method is a method of estimating an age by height after person recognition. When a highly accurate age estimation is required, the first method may be adopted. When it is only necessary to distinguish between, for example, a child and an adult to some extent, the second method may be adopted. By the second method, information generator 26 may identify a person who is a first predetermined height or less as a child, and identify a person who is a second predetermined height or more as an adult. The first predetermined height and the second predetermined height may be the same numerical value or different numerical values. For example, the first predetermined height may be 120 cm and the second predetermined height may be 155 cm. In this case, when the person is taller than 120 cm and shorter than 155 cm in height, information generator 26 may identify this person as an adult with no exception, estimate the age by facial recognition, or estimate the age by the clothes the person is wearing.

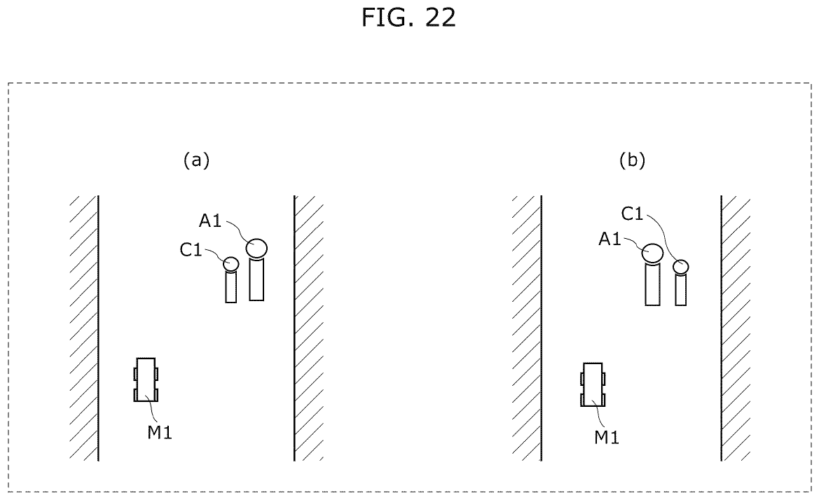

Next, another example of correcting an individual risk is described with reference to FIG. 22. The following describes an example where risk corrector 25 further corrects the individual risk when a predetermined condition is satisfied.

The predetermined condition may be that the group includes a person who is on a blacklist. The blacklist includes information that identifies a person who has obstructed first mobile body M1 from running in the past, or more specifically, information that identifies a person who made a mischief on first mobile body M1 in the past. When the group includes a person who is on a blacklist, risk corrector 25 may correct the risk correction value in table T5 of FIG. 10 to increase the individual risk and then correct the individual risk using this risk correction value. Note that whether the person is on the blacklist may be determined by identifying the person by facial recognition. However, this is not intended to be limiting.

The predetermined condition may be that a group includes second mobile bodies that share the same condition (such as the same position and the same situation) and have different individual risks. The same position may also indicate that these second mobile bodies are within a predetermined distance of each other. One example of the second mobile bodies sharing the same condition and having the different individual risks is a parent and a child. In this case, depending on whether the second mobile body located closer to first mobile body M1 has the higher or lower individual risk, risk corrector 25 may vary the correction degree by which the individual risk is corrected. For example, when the person closer to first mobile body M1 has the higher individual risk (the child, for example), risk corrector 25 may perform the correction to reduce the correction degree by which the individual risk is corrected (that is, perform the correction to increase the individual risk). When the person closer to first mobile body M1 has the lower individual risk (the adult, for example), risk corrector 25 may perform the correction to increase the correction degree by which the individual risk is corrected (that is, perform the correction to reduce the individual risk). For the second mobile bodies sharing the same condition and having the different individual risks, risk corrector 25 may correct the risk correction values in table T5 of FIG. 10 according to which second mobile body is on the side closer to first mobile body M1 and then correct the individual risk using the corrected risk correction value.

FIG. 22 is a diagram illustrating an example of the risk correction based on a positional relationship between first mobile body M1 and second mobile bodies in a group, according to the present variation. In (a) of FIG. 22, the child, out of the parent and the child, is on the side closer to first mobile body M1. In (b) of FIG. 22, the parent, out of the parent and the child, is on the side closer to first mobile body M1. Note that the individual risk of the parent (second mobile body A1) is lower than the individual risk of the child (second mobile body C1).

Out of the parent and the child as illustrated in (a) of FIG. 22, the child having the higher individual risk is on the side closer to first mobile body M1 (that is, the child is closer to first mobile body M1). Thus, risk corrector 25 reduces the correction degree by which the individual risk is corrected. More specifically, risk corrector 25 performs the correction to increase the individual risk of the child.

Out of the parent and the child as illustrated in (b) of FIG. 22, the parent having the lower individual risk is on the side closer to first mobile body M1 (that is, the parent is closer to first mobile body M1). Thus, risk corrector 25 increases the correction degree by which the individual risk is corrected. More specifically, risk corrector 25 performs the correction to reduce the individual risk of the child.

Next, the above embodiment describes the example where, after the individual risk calculation, the individual risk calculated for each of the at least two second mobile bodies is corrected when the at least two second mobile bodies has the predetermined relationship. However, the individual risk calculation and the individual risk correction need not be performed. For example, the information processing method executed by the information processing device according to one aspect of the present disclosure may include: obtaining sensing information generated by imaging surroundings of first mobile body M1 that travels autonomously; detecting a second mobile body present in the vicinity of first mobile body M1, based on the sensing information; determining, when the second mobile body detected in the vicinity of first mobile body M1 comprises at least two second mobile bodies, whether the at least two second mobile bodies have a predetermined relationship, based on the sensing information; and executing, when it is determined that the at least two second mobile bodies have the predetermined relationship, a predetermined operation to prevent contact between first mobile body M1 and the at least two second mobile bodies. The predetermined operation may be an operation for varying the presentation of the alert display that is displayed on terminal D1. Alternatively, the predetermined operation may be an operation for varying the utterance from first mobile body M1 to the group. Furthermore, the predetermined operation may be an operation for causing first mobile body M1 to stop until the two second mobile bodies having the predetermined relationship have passed by the obstacle. Furthermore, the predetermined operation may include: calculating, for each of the at least two second mobile bodies, an individual risk indicating a possibility of coming into contact with first mobile body M1; correcting the individual risk calculated for each of the at least two second mobile bodies; and notifying at least one of first mobile body M1 or the terminal used by the remote supervisor, about information on the corrected individual risk. In this case, the information on the corrected individual risk includes at least one of the control information or the notice information, for example.

### Supplementary Notes

A group in the present disclosure refers to a set of second mobile bodies having a predetermined relationship. For example, when an adult is paying close attention to a child, when a pedestrian is walking a dog on a leash, or when children on bicycles are traveling in the same direction, it can be determined that these second mobile bodies have the predetermined relationship and belong to a group. In contrast, when the second mobile bodies pass each other, when the distance between the second mobile bodies is long, or when an adult and a child are close to each other but not looking at each other, it is determined that these second mobile bodies do not have the predetermined relationship and do not belong to a group.

Furthermore, as described above, a risk in the present disclosure refers to a level of possibility that the second mobile body collides with first mobile body M1 that is a vehicle for example. For example, such a risk is indicated numerically. For a higher risk value, the danger can be determined to be higher. The level of the individual risk is calculated by reflecting physical conditions, such as: the distance between first mobile body M1 that is a vehicle and the second mobile body that is a pedestrian for example; the speed and the traveling direction of first mobile body M1; the speed and the traveling direction of the second mobile body; and the presence or absence of an obstacle between first mobile body M1 and the second mobile body. Furthermore, the level of the individual risk is calculated also by reflecting, in addition to the aforementioned physical conditions, the attributes of the second mobile body, such as age, gender, and clothes. For example, for the second mobile body that is an adult pedestrian and the second mobile body that is a child on a bicycle both under the same physical conditions, a higher individual risk is calculated for the latter.

The description on the above embodiment discloses the following technologies.

### Technique 1

An information processing method executed by an information processing device includes: obtaining sensing information generated by sensing a vicinity of a first mobile body that travels autonomously; detecting a second mobile body present in the vicinity of the first mobile body, based on the sensing information obtained in the obtaining; determining, when at least two second mobile bodies are detected in the detecting as the second mobile body present in the vicinity of the first mobile body, whether the at least two second mobile bodies have a predetermined relationship, based on the sensing information; and executing, when the determining is made that the at least two second mobile bodies have the predetermined relationship, a predetermined operation to avoid contact between the first mobile body and the at least two second mobile bodies.

As described above, whether the at least two second mobile bodies have the predetermined relationship is determined based on the sensing information, and then the predetermined operation is performed to keep the at least two second mobile bodies from coming into contact with the first mobile body. By the information processing method, the predetermined operation is performed to keep the first mobile body from performing an unnecessary operation, and necessary and sufficient control is performed on the first mobile body.

### Technique 2

The information processing method according to technique 1 further includes: calculating, for each of the at least two second mobile bodies, an individual risk indicating a possibility of coming into contact with the first mobile body, based on a first position of the first mobile body and a second position of the second mobile body, wherein, when the at least two second mobile bodies have the predetermined relationship, the executing includes, as the predetermined operation: correcting the individual risk calculated for each of the at least two second mobile bodies; and notifying at least one of the first mobile body or a terminal used by a remote supervisor who remotely supervises or operates the first mobile body, about information on the individual risk corrected.

With this, each of the individual risks calculated for the at least two second mobile bodies can be corrected. Thus, a more accurate risk assessment can be obtained for the second mobile body. This allows necessary and sufficient control to be performed on the first mobile body. Furthermore, the number of interventions or remote operations performed by the remote supervisor of first mobile body M1 can be reduced, and thus the load on the remote supervisor can also be reduced.

### Technique 3

The information processing method according to technique 2 further includes: obtaining state information on a traveling state of the first mobile body; and determining, when the at least two second mobile bodies have the predetermined relationship, the second position and an attribute of each of the at least two second mobile bodies detected, wherein the calculating of the individual risk is performed based on the state information obtained in the obtaining and the second position determined in the determining for each of the at least two second mobile bodies, and the determining whether the at least two second mobile bodies have the predetermined relationship is performed based on the second position and the attribute determined for each of the at least two second mobile bodies.

With this, the individual risk calculation and the determination whether the at least two second mobile bodies have the predetermined relationship can be performed more accurately by using the state information and the attributes.

### Technique 4

In the information processing method according to technique 2, the information on the individual risk corrected includes at least one of: control information for controlling the first mobile body; or notice information for providing notice to the remote supervisor, and in the notifying, at least one of the control information or the notice information in the information on the individual risk corrected is notified.

With this, the notice is provided to the first mobile body or the remote supervisor. This allows necessary and sufficient control to be performed on the first mobile body.

### Technique 5

In the information processing method according to any one of techniques 1 to 4, the sensing information is video information that includes at least one piece of image information generated by capturing the vicinity of the first mobile body.

With this, the detection of the at least two second mobile bodies and the determination of the position and attribute for each of the at least two second mobile bodies can be easily performed by using the video information. Furthermore, the determination whether the at least two second mobile bodies have the predetermined relationship can also be easily made by using the video information.

### Technique 6

In the information processing method according to technique 3, the state information includes a traveling speed, a traveling direction, and the traveling state of the first mobile body.

With this, the traveling speed, the traveling direction, and the traveling state of the first mobile body that are included in the state information can be used. This enables a more accurate calculation of the individual risk.

### Technique 7

In the information processing method according to technique 3, in the correcting, when the individual risk is different for each of the at least two second mobile bodies, the individual risk calculated for a second mobile body corresponding to a higher individual risk than another second mobile body among the at least two second mobile bodies is reduced based on at least one of a type or the attribute of each of the at least two second mobile bodies.

With this, the correction is performed to reduce the individual risk, based on at least one of the type or the attribute of the corresponding second mobile body. This enables a more accurate calculation of the individual risk.

### Technique 8

In the information processing method according to any one of techniques 2 to 4, 6, and 7, in the correcting, the individual risk calculated for each of the at least two second mobile bodies is corrected with reference to a table that includes a type, an attribute, and a correction value for each of the at last two second mobile bodies.

With this, the individual risk is calculated by using the table. This enables the individual risk to be calculated more easily with less computational load.

### Technique 9

In the information processing method according to technique 8, in the correcting, when the at least two second mobile bodies detected are two second mobile bodies that are one person aged at least a predetermined age and one child under the predetermined age, the individual risk calculated for a second mobile body that is the one child out of the two second mobile bodies is reduced with reference to the table.

As described above, the individual risks calculated for the two second mobile bodies corresponding to the one person aged at least the predetermined age and the one child under the predetermined age are corrected by reflecting that the two second mobile bodies have the predetermined relationship. This allows a more accurate risk assessment to be made for the two second mobile bodies corresponding to the one person aged at least the predetermined age and the one child under the predetermined age.

### Technique 10

In the information processing method according to technique 8, in the correcting, when each of the at least two second mobile bodies detected is a child under a predetermined age, the individual risk calculated for each of the at least two second mobile bodies is increased with reference to the table.

As described above, the individual risks calculated for the two second mobile bodies corresponding to the children under the predetermined age are corrected by reflecting that the two second mobile bodies have the predetermined relationship. This allows a more accurate risk assessment to be made for the two second mobile bodies corresponding to the children under the predetermined age.

### Technique 11

In the information processing method according to technique 8, in the correcting, when the at least two second mobile bodies detected include one adult and two or more children under a predetermined age, the individual risk calculated for each of two or more second mobile bodies that are the two or more children out of the at least two second mobile bodies is reduced with reference to the table.

As described above, the individual risks calculated for the at least two second mobile bodies including the one adult and the at least two children under the predetermined age are corrected by reflecting that the at least two second mobile bodies have the predetermined relationship. This allows a more accurate risk assessment to be made for the at least two second mobile bodies including the one adult and the at least two children under the predetermined age.

### Technique 12

In the information processing method according to any one of techniques 1 to 11, the determining whether the at least two second mobile bodies have the predetermined relationship is performed based on group determination information on at least one of a distance, line of sight, physical connection, belongings, movements, ages, or voices, detected between the at least two second mobile bodies.

As described above, whether the at least two second mobile bodies have the predetermined relationship is easily determined by using, as the group determination information, at least one of the distance, the line of sight, the physical connection, the belongings, the movements, the ages, or the voices, detected between the at least two second mobile bodies.

### Technique 13

The information processing method according to technique 4 further includes: generating, as the control information, based on the individual risk corrected, information for causing the first mobile body to perform at least one of: control for making a temporary stop; control for performing an avoidance action; control for calling attention using speech; or control for turning a light on.

As described above, at least one of: the control for making a temporary stop; the control for performing an avoidance action; control for the calling attention using speech; or the control for turning a light on is generated as the control information for the first mobile body. With this, according to the corrected risk value, the control information for the first mobile body can be easily generated without any load.

### Technique 14

The information processing method according to technique 4 further includes: generating, as the notice information, based on the individual risk corrected, alert information indicating an alert that encourages the remote supervisor to pay close attention to the first mobile body or to operate the first mobile body.

As described above, the alert information indicating the alert that causes the remote supervisor to pay close attention to the first mobile body or to operate the first mobile body is generated as the notice information. With this, according to the corrected risk value, the notice information can be easily generated without any load.

### Technique 15

In the information processing method according to technique 14, the notice information includes information indicating at least one of: a size of alert display indicating the alert; a color of the alert display; whether to flash the alert display; a volume level of notice sound for the alert; or a sound pitch of the notice sound.

With this, different kinds of notice as the notice information can be provided.

### OTHER EMBODIMENTS

Although the information processing method and the like according to one or more aspects of the present disclosure have been described based on an embodiment, the present disclosure is not limited to this embodiment. Those skilled in the art will readily appreciate that embodiments arrived at by making various modifications to the above embodiment or embodiments arrived at by selectively combining elements disclosed in the above embodiment without materially departing from the scope of the present disclosure may be included within one or more aspects of the present disclosure.

Each of the elements in each of the above embodiments may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory.

It should be noted that the present disclosure may also include the following embodiments.
(1) Each of one or more devices described above may specifically be a computer system including, for example, a microprocessor, ROM (Read Only Memory), and RAM (Random Access Memory), a hard disk unit, a display unit, a keyboard, a mouse, and the like. The RAM or the hard disk unit holds a computer program. The microprocessor operates according to the computer program to cause each of the one or more devices described above to execute its function. Here, the computer program includes combinations of instruction codes for issuing instructions to the computer to execute predetermined functions.
(2) A part or all of constituent elements in each of the one or more devices described above may be implemented into a single Large Scale Integration (LSI). The system LSI is a multi-functional LSI in which a plurality of elements are integrated into a single chip. An example of such a system LSI is a computer system including a microprocessor, a ROM, a Random Access Memory (RAM), and the like. The microprocessor operates according to the computer program to cause the system LSI to execute its function.
(3) A part or all of the constituent elements included in each of the one or more devices described above may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to execute its functions. The IC card or the module may have tamper resistance.
(4) The present disclosure may be the above-above described methods. These methods may be a computer program executed by a computer, or digital signals forming the computer program.

The present disclosure may be a computer-readable recording medium on which the computer program or the digital signals are recorded. Examples of the computer-readable recording medium are a flexible disk, a hard disk, a Compact Disc-Read Only Memory (CD-ROM), a magnetooptic disk (MO), a Digital Versatile Disc (DVD), a DVD-ROM, a DVD-RAM, a BD (Blu-ray (registered trademark) Disc), and a semiconductor memory. The present disclosure may be the digital signals recorded on the recording medium.

The present disclosure may be implemented by transmitting the computer program or the digital signals via an electric communication line, a wired or wireless communication line, a network represented by the Internet, data broadcasting, and the like.

It is also possible that the program or the digital signals may be recorded onto the recording medium to be transferred, or may be transmitted via a network or the like, so that the program or the digital signals can be executed by a different independent computer system.

### INDUSTRIAL APPLICABILITY

The present disclosure is applicable to, for example, a method of outputting control information used by a remote supervisor for supervising or remotely operating a first mobile body that is an operation target.

1. An information processing method executed by an information processing device, the information processing method comprising:
obtaining sensing information generated by sensing a vicinity of a first mobile body that travels autonomously;
detecting a second mobile body present in the vicinity of the first mobile body, based on the sensing information obtained in the obtaining;
determining, when at least two second mobile bodies are detected in the detecting as the second mobile body present in the vicinity of the first mobile body, whether the at least two second mobile bodies have a predetermined relationship, based on the sensing information; and
executing, when the determining is made that the at least two second mobile bodies have the predetermined relationship, a predetermined operation to avoid contact between the first mobile body and the at least two second mobile bodies.

2. The information processing method according to claim 1, further comprising:
calculating, for each of the at least two second mobile bodies, an individual risk indicating a possibility of coming into contact with the first mobile body, based on a first position of the first mobile body and a second position of the second mobile body,
wherein, when the at least two second mobile bodies have the predetermined relationship, the executing includes, as the predetermined operation:
correcting the individual risk calculated for each of the at least two second mobile bodies; and
notifying at least one of the first mobile body or a terminal used by a remote supervisor who remotely supervises or operates the first mobile body, about information on the individual risk corrected.

3. The information processing method according to claim 2, further comprising:
obtaining state information on a traveling state of the first mobile body; and
determining, when the at least two second mobile bodies have the predetermined relationship, the second position and an attribute of each of the at least two second mobile bodies detected,
wherein the calculating of the individual risk is performed based on the state information obtained in the obtaining and the second position determined in the determining for each of the at least two second mobile bodies, and
the determining whether the at least two second mobile bodies have the predetermined relationship is performed based on the second position and the attribute determined for each of the at least two second mobile bodies.

4. The information processing method according to claim 2,
wherein the information on the individual risk corrected includes at least one of: control information for controlling the first mobile body; or notice information for providing notice to the remote supervisor, and
in the notifying, at least one of the control information or the notice information in the information on the individual risk corrected is notified.

5. The information processing method according to claim 1,
wherein the sensing information is video information that includes at least one piece of image information generated by capturing the vicinity of the first mobile body.

6. The information processing method according to claim 3,
wherein the state information includes a traveling speed, a traveling direction, and the traveling state of the first mobile body.

7. The information processing method according to claim 3,
wherein in the correcting,
when the individual risk is different for each of the at least two second mobile bodies, the individual risk calculated for a second mobile body corresponding to a higher individual risk than another second mobile body among the at least two second mobile bodies is reduced based on at least one of a type or the attribute of each of the at least two second mobile bodies.

8. The information processing method according to claim 2,
wherein in the correcting,
the individual risk calculated for each of the at least two second mobile bodies is corrected with reference to a table that includes a type, an attribute, and a correction value for each of the at last two second mobile bodies.

9. The information processing method according to claim 8,
wherein in the correcting,
when the at least two second mobile bodies detected are two second mobile bodies that are one person aged at least a predetermined age and one child under the predetermined age, the individual risk calculated for a second mobile body that is the one child out of the two second mobile bodies is reduced with reference to the table.

10. The information processing method according to claim 8,
wherein in the correcting,
when each of the at least two second mobile bodies detected is a child under a predetermined age, the individual risk calculated for each of the at least two second mobile bodies is increased with reference to the table.

11. The information processing method according to claim 8,
wherein in the correcting,
when the at least two second mobile bodies detected include one adult and two or more children under a predetermined age, the individual risk calculated for each of two or more second mobile bodies that are the two or more children out of the at least two second mobile bodies is reduced with reference to the table.

12. The information processing method according to claim 1,
wherein the determining whether the at least two second mobile bodies have the predetermined relationship is performed based on group determination information on at least one of a distance, line of sight, physical connection, belongings, movements, ages, or voices, detected between the at least two second mobile bodies.

13. The information processing method according to claim 4, further comprising:
generating, as the control information, based on the individual risk corrected, information for causing the first mobile body to perform at least one of: control for making a temporary stop; control for performing an avoidance action; control for calling attention using speech; or control for turning a light on.

14. The information processing method according to claim 4, further comprising:
generating, as the notice information, based on the individual risk corrected, alert information indicating an alert that encourages the remote supervisor to pay close attention to the first mobile body or to operate the first mobile body.

15. The information processing method according to claim 14,
wherein the notice information includes
information indicating at least one of: a size of alert display indicating the alert; a color of the alert display; whether to flash the alert display; a volume level of notice sound for the alert; or a sound pitch of the notice sound.

16. An information processing device comprising:
an obtainer that obtains sensing information generated by sensing a vicinity of a first mobile body that travels autonomously;
a detector that detects a second mobile body present in the vicinity of the first mobile body, based on the sensing information obtained by the obtainer;
a group relationship determiner that determines, when the detector detects at least two second mobile bodies as the second mobile body present in the vicinity of the first mobile body, whether the at least two second mobile bodies have a predetermined relationship, based on the sensing information; and
an executer that executes, when the group relationship determiner determines that the at least two second mobile bodies have the predetermined relationship, a predetermined operation to avoid contact between the first mobile body and the at least two second mobile bodies.

17. A non-transitory computer-readable recording medium having recorded thereon a program for causing a computer to execute:
obtaining sensing information generated by sensing vicinity of a first mobile body that travels autonomously;
detecting a second mobile body present in the vicinity of the first mobile body, based on the sensing information obtained in the obtaining;
determining, when at least two second mobile bodies are detected in the detecting as the second mobile body present in the vicinity of the first mobile body, whether the at least two second mobile bodies have a predetermined relationship, based on the sensing information; and
executing, when the determining is made that the at least two second mobile bodies have the predetermined relationship, a predetermined operation to avoid contact between the first mobile body and the at least two second mobile bodies.
